(19) United States
(12) Patent Application Publication
(10) Pub. No.: US 2012/0242142 A1
(43) Pub. Date: Sep. 27, 2012

(54) Track Assembly for Traction of a Vehicle

(75) Inventors: Dewaine Kautsch, Jefferson City, MO (US); Alain Lussier, St-Francois-Xavier-de-Brompton (CA)

(73) Assignee: CAMOPLAST SOLIDEAL INC., Sherbrooke, QC (CA)

(21) Appl. No.: 13/499,655

(22) PCT Filed: Oct. 1, 2010
(86) PCT No.: PCT/US10/51166

§ 371 Date: Jun. 12, 2012

Related U.S. Application Data
(60) Provisional application No. 61/272,512, filed on Oct. 1, 2009.
(60) Provisional application No. 61/282,834, filed on Apr. 7, 2010.

(51) Int. Cl. B62D 55/08; B62D 55/14; B62D 55/12

(52) U.S. Cl. 305/142; 305/165; 305/124

(57) ABSTRACT

A track assembly for providing traction to a vehicle, such as an agricultural vehicle, a construction vehicle, or another work vehicle The track assembly is mountable to an axle of the vehicle The track assembly comprises a plurality of wheels comprising a leading idler wheel and a trailing idler wheel spaced apart in a longitudinal direction of the track assembly, an axis of rotation of the axle of the vehicle being located between an axis of rotation of the leading idler wheel and an axis of rotation of the trailing idler wheel in the longitudinal direction of the track assembly, and a driver wheel for rotating when the axle of the vehicle rotates The track assembly also comprises an endless track disposed around the wheels The endless track comprises an inner side facing the wheels and a ground-engaging outer side for engaging the ground The endless track engages the driver wheel such that rotation of the driver wheel imparts motion to the endless track.

### CROSS-REFERENCE TO RELATED APPLICATIONS

This application claims priority from U.S. Patent Application No. 61/272,512 filed on Oct. 1, 2009 and U.S. Patent Application No. 61/282,834 filed on Apr. 7, 2010, which are incorporated by reference herein.

### FIELD OF THE INVENTION

The invention relates to track assemblies for traction of vehicles operable off-road.

### BACKGROUND

Certain work vehicles, such as agricultural vehicles (e.g., harvesters, combines, tractors, etc.), construction vehicles (e.g., loaders, bulldozers, excavators, etc.), forestry vehicles (e.g., feller-bunchers, tree chippers, knuckleboom loaders, etc.) and military vehicles (e.g., combat engineering vehicles (CEVs), etc.) to name a few, are used in agricultural fields, construction sites and other areas with a variety of ground surfaces which may be soft, slippery and/or uneven (e.g., soil, mud, sand, ice, snow, etc.).

Some work vehicles ride on tires that propel them on the ground. As they are typically quite heavy and their weight is distributed over a relatively small ground area by their tires, these vehicles apply relatively high pressure on the ground. This high pressure tends to compact the ground on which the vehicles are supported and such ground compaction can be undesirable (e.g., compacted soil can discourage crop growth or otherwise adversely affect the area being compacted). Also, as the tires provide a relatively small contact surface with the ground, traction of these vehicles is often limited, particularly on wet grounds.

To address these drawbacks, some work vehicles have been provided with track assemblies instead of ground-engaging wheels with tires. These track assemblies typically have elastomeric endless tracks which enhance floatation and traction of the vehicles on the ground. However, existing track assemblies tend to adversely affect other aspects of the performance of the vehicles. For example, existing track assemblies tend to limit a speed at which the vehicles can be operated, especially in cases where they are used in place of ground-engaging wheels on which the vehicles were designed to be propelled.

For these and other reasons, there is a need to improve track apparatuses for traction of work vehicles.

### SUMMARY OF THE INVENTION

In accordance with a broad aspect, the invention provides a track assembly for providing traction to a vehicle. The track assembly is mountable to an axle of the vehicle. The track assembly comprises a plurality of wheels comprising: a leading idler wheel and a trailing idler wheel spaced apart in a longitudinal direction of the track assembly, an axis of rotation of the axle of the vehicle being located between an axis of rotation of the leading idler wheel and an axis of rotation of the trailing idler wheel in the longitudinal direction of the track assembly; and a driver wheel for rotating when the axle of the vehicle rotates. The driver wheel comprises a friction drive surface. The track assembly also comprises an endless track disposed around the wheels. The endless track comprises an inner side facing the wheels and a ground-engaging outer side for engaging the ground.

The inner side of the endless track comprises a friction drive surface for frictionally contacting the friction drive surface of the driver wheel such that, when the driver wheel rotates, friction between the friction drive surface of the driver wheel and the friction drive surface of the endless track causes motion of the endless track to propel the vehicle on the ground.

In accordance with another broad aspect, the invention provides a track assembly for providing traction to a vehicle. The track assembly is mountable to an axle of the vehicle. The track assembly comprises a plurality of wheels comprising: a leading idler wheel and a trailing idler wheel spaced apart in a longitudinal direction of the track assembly, an axis of rotation of the axle of the vehicle being located between an axis of rotation of the leading idler wheel and an axis of rotation of the trailing idler wheel in the longitudinal direction of the track assembly; and a driver wheel for rotating when the axle of the vehicle rotates. The track assembly also comprises a transmission for transmitting power from the axle of the vehicle to the driver wheel such that a rotational speed of the driver wheel is different from a rotational speed of the axle of the vehicle. The track assembly also comprises an endless track disposed around the wheels. The endless track comprises an inner side facing the wheels and a ground-engaging outer side for engaging the ground. The endless track engages the driver wheel such that rotation of the driver wheel imparts motion to the endless track.

In accordance with another broad aspect, the invention provides a track assembly for providing traction to a vehicle. The track assembly is mountable to an axle of the vehicle. The track assembly comprises a plurality of wheels comprising: a leading idler wheel and a trailing idler wheel spaced apart in a longitudinal direction of the track assembly, an axis of rotation of the axle of the vehicle being located between an axis of rotation of the leading idler wheel and an axis of rotation of the trailing idler wheel in the longitudinal direction of the track assembly; and a driver wheel for rotating when the axle of the vehicle rotates. The track assembly also comprises an endless track disposed around the wheels. The endless track comprises an inner side facing the wheels and a ground-engaging outer side for engaging the ground. The endless track engages the driver wheel such that rotation of the driver wheel imparts motion to the endless track. A ratio V/V_{w} of a vertical distance V between the axis of rotation of the axle of the vehicle and the ground when the track assembly is mounted to the axle of the vehicle and a vertical distance V_{w} between the axis of rotation of the axle of the vehicle and the ground when a ground-engaging wheel specified for the vehicle is mounted to the axle of the vehicle instead of the track assembly is between 0.9 and 1.1.

In accordance with another broad aspect, the invention provides a track assembly for providing traction to a vehicle. The track assembly is mountable to an axle of the vehicle. The track assembly comprises a plurality of wheels comprising: a leading idler wheel and a trailing idler wheel spaced apart in a longitudinal direction of the track assembly, an axis of rotation of the axle of the vehicle being located between an axis of rotation of the leading idler wheel and an axis of rotation of the trailing idler wheel in the longitudinal direction of the track assembly; and a driver wheel for rotating when the axle of the vehicle rotates. The track assembly also comprises an endless track disposed around the wheels. The endless track comprises an inner side facing the wheels and a ground-engaging outer side for engaging the ground. The endless track engages the driver wheel such that rotation of the driver wheel imparts motion to the endless track. A ratio S/S_{w} of a maximum operational speed S of the vehicle when the track assembly is mounted to the axle of the vehicle and a maximum operational speed S_{w} of the vehicle when a ground-engaging wheel specified for the vehicle is mounted to the axle of the vehicle instead of the track assembly is at least 0.8.

In accordance with another broad aspect, the invention provides a track assembly for providing traction to a vehicle. The track assembly is mountable to an axle of the vehicle. The track assembly comprises a frame and a plurality of wheels, which comprises: a leading idler wheel and a trailing idler wheel spaced apart in a longitudinal direction of the track assembly and mounted to the frame, an axis of rotation of the axle of the vehicle being located between an axis of rotation of the leading idler wheel and an axis of rotation of the trailing idler wheel in the longitudinal direction of the track assembly; and a driver wheel for rotating when the axle of the vehicle rotates. The track assembly also comprises an endless track disposed around the wheels. The endless track comprises an inner side facing the wheels and a ground-engaging outer side for engaging the ground. The endless track engages the driver wheel such that rotation of the driver wheel imparts motion to the endless track. The track assembly also comprises a suspension comprising an elastic element to allow movement of a lower portion of the frame relative to an upper portion of the frame.

In accordance with another broad aspect, the invention provides a track assembly for providing traction to a vehicle. The track assembly is mountable to an axle of the vehicle. The track assembly comprises a plurality of wheels comprising: a leading idler wheel and a trailing idler wheel spaced apart in a longitudinal direction of the track assembly, an axis of rotation of the axle of the vehicle being located between an axis of rotation of the leading idler wheel and an axis of rotation of the trailing idler wheel in the longitudinal direction of the track assembly; and a driver wheel for rotating when the axle of the vehicle rotates. The track assembly also comprises an endless track disposed around the wheels. The endless track comprises an inner side facing the wheels and a ground-engaging outer side for engaging the ground. The endless track engages the driver wheel such that rotation of the driver wheel imparts motion to the endless track. The track assembly also comprises an active tensioning system for maintaining the endless track in tension. The active tensioning system is configured to urge a given one of the leading idler wheel and the trailing idler wheel in a direction to maintain the endless track in tension.

In accordance with another broad aspect, the invention provides a track assembly for providing traction to a vehicle. The track assembly is mountable to an axle of the vehicle. The track assembly comprises a plurality of wheels comprising: a leading idler wheel and a trailing idler wheel spaced apart in a longitudinal direction of the track assembly, an axis of rotation of the axle of the vehicle being located between an axis of rotation of the leading idler wheel and an axis of rotation of the trailing idler wheel in the longitudinal direction of the track assembly; and a driver wheel for rotating when the axle of the vehicle rotates. The track assembly also comprises an endless track disposed around the wheels. The endless track comprises an inner side facing the wheels and a ground-engaging outer side for engaging the ground. The endless track engages the driver wheel such that rotation of the driver wheel imparts motion to the endless track. The track assembly is configured such that a resultant tension force from the endless track at the trailing idler wheel is oriented to intersect the axle of the vehicle.

In accordance with another broad aspect, the invention provides a track assembly for providing traction to a vehicle. The track assembly is mountable to an axle of the vehicle. The track assembly is pivotable about a pivot axis corresponding to an axis of rotation of the axle of the vehicle. The track assembly comprises a plurality of wheels comprising: a leading idler wheel and a trailing idler wheel spaced apart in a longitudinal direction of the track assembly, the axis of rotation of the axle of the vehicle being located between an axis of rotation of the leading idler wheel and an axis of rotation of the trailing idler wheel in the longitudinal direction of the track assembly; and a driver wheel for rotating when the axle of the vehicle rotates. The track assembly also comprises an endless track disposed around the wheels. The endless track comprises an inner side facing the wheels and a ground-engaging outer side for engaging the ground. The endless track engages the driver wheel such that rotation of the driver wheel imparts motion to the endless track. The track assembly also comprises an anti-rotation connector for connecting the track assembly to a frame of the vehicle to limit a pivot movement of the track assembly relative to the frame of the vehicle. The anti-rotation connector comprises a first portion and a second portion movable relative to one another and interacting via an elastic element.

These and other aspects of the invention will now become apparent to those of ordinary skill in the art upon review of the following description of embodiments of the invention in conjunction with the accompanying drawings.

### BRIEF DESCRIPTION OF THE DRAWINGS

A detailed description of embodiments of the invention is provided below, by way of example only, with reference to the accompanying drawings, in which:

FIG. 1 shows an example of a work vehicle in accordance with an embodiment of the invention;

FIG. 2 shows a perspective view of a track assembly of the vehicle in accordance with an embodiment of the invention;

FIG. 2A shows another perspective view of the track assembly;

FIG. 3 shows a longitudinal cross-sectional view of the track assembly;

FIG. 3A shows certain forces on a rear idler wheel of the track assembly;

FIG. 4 shows a transversal cross-sectional view of the track assembly;

FIG. 5 shows a perspective view of the track assembly without an endless track thereof;

FIG. 6 shows a perspective view of the track assembly without the endless track and without a drive wheel member thereof;

FIG. 7 shows another perspective view of the track assembly without the endless track and without another drive wheel member thereof;

FIG. 8 shows a longitudinal view of the track assembly without some components;

FIG. 9 shows a top view of an idler wheel of the track assembly and examples of an alignment angle thereof;

FIG. 10 shows the vehicle provided with front ground-engaging wheels;

FIG. 11 shows a perspective view of a track assembly of the vehicle in accordance with another embodiment of the invention;

FIG. 11A snows another perspective view of the track assembly of FIG. 11, showing an anti-rotation connector of the track assembly;

FIG. 12 shows a longitudinal view of the track assembly of FIG. 11;

FIG. 13 shows a longitudinal cross-sectional view of the track assembly of FIG. 11;

FIG. 14 shows a transversal cross-sectional view of the track assembly of FIG. 11;

FIG. 15 shows a perspective cross-sectional view of the track assembly of FIG. 11;

FIG. 16 shows a perspective view of the track assembly of FIG. 11 without an endless track thereof;

FIG. 17 shows a longitudinal view of the track assembly of FIG. 11 without the endless track;

FIG. 18 shows a perspective view of the track assembly of FIG. 11 without some components;

FIG. 19 shows another perspective view of the track assembly of FIG. 11 without some components;

FIG. 20 shows a perspective view of a track assembly of the vehicle in accordance with another embodiment of the invention;

FIG. 21 shows a perspective cross-sectional view of the track assembly of FIG. 20;

FIG. 22 shows another example of a work vehicle in accordance with an embodiment of the invention; and

FIG. 23 shows the vehicle of FIG. 22 provided with front ground-engaging wheels and rear ground-engaging wheels.

It is to be expressly understood that the description and drawings are only for the purpose of illustrating certain embodiments of the invention and are an aid for understanding. They are not intended to be a definition of the limits of the invention.

### DETAILED DESCRIPTION OF EMBODIMENTS

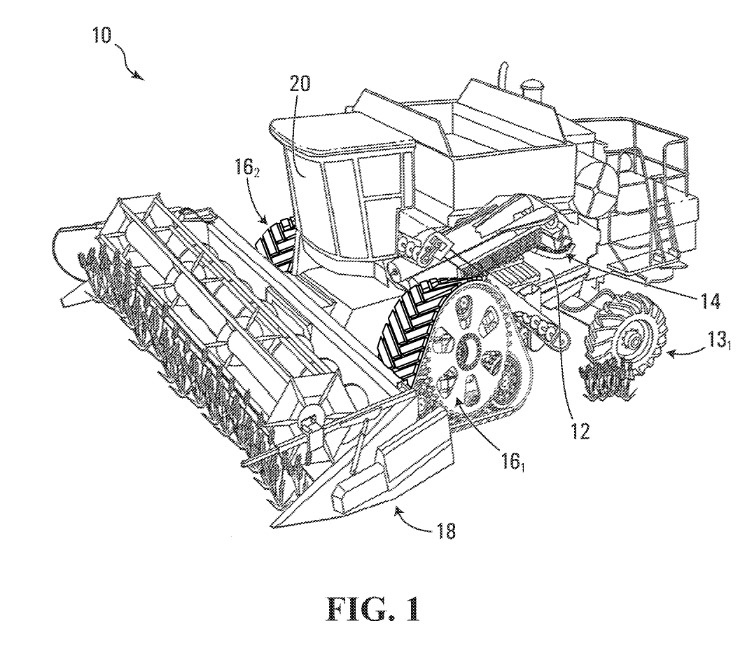

FIG. 1 shows a work vehicle 10 in accordance with an embodiment of the invention. In this embodiment, the work vehicle 10 is an agricultural vehicle for performing agricultural work. More specifically, in this example, the agricultural vehicle 10 is a combine harvester. In other examples, the agricultural vehicle 10 may be another type of harvester, a tractor or any other type of agricultural vehicle.

The agricultural vehicle 10 comprises a frame 12 supporting a prime mover 14, a plurality of track assemblies 16₁, 16₂ (which can be referred to as “undercarriages”), a plurality of ground-engaging wheels 13₁, 13₂, a working implement 18, and an operator cabin 20, which enable an operator to move the agricultural vehicle 10 on the ground to perform agricultural work.

The prime mover 14 generates motive power to move the agricultural vehicle 10. For example, the prime mover 14 may comprise an internal combustion engine and/or one or more other types of motors (e.g., an electric motor) for generating motive power to move the agricultural vehicle 10. The prime mover 14 is in a driving relationship with each of the track assemblies 16₁, 16₂. That is, power derived from the prime mover 14 is transmitted to each of the track assemblies 16₁, 16₂ via a powertrain of the agricultural vehicle 10 in order to drive the track assemblies 16₁, 16₂. Similarly, in this case, power derived from the prime mover 14 is transmitted to each of the ground-engaging wheels 13₁, 13₂ via the powertrain of the agricultural vehicle 10 in order to drive these wheels.

The working implement 18 is used to perform agricultural work. In this embodiment, the working implement 18 is a combine head that can be used to cut and/or otherwise process crops. In other embodiments, the working implement 18 may take on various other forms, such as a cutter, a scraper, a tiller or any other type of agricultural working implement.

The operator cabin 20 is where the operator sits and controls the agricultural vehicle 10. More particularly, the operator cabin 20 comprises a set of controls that allow the operator to steer the agricultural vehicle 10 on the ground, operate the working implement 18 and control other aspects of the vehicle 10.

The track assemblies 16₁, 16₂ and the ground-engaging wheels 13₁, 13₂ are used to propel the agricultural vehicle 10 on the ground.

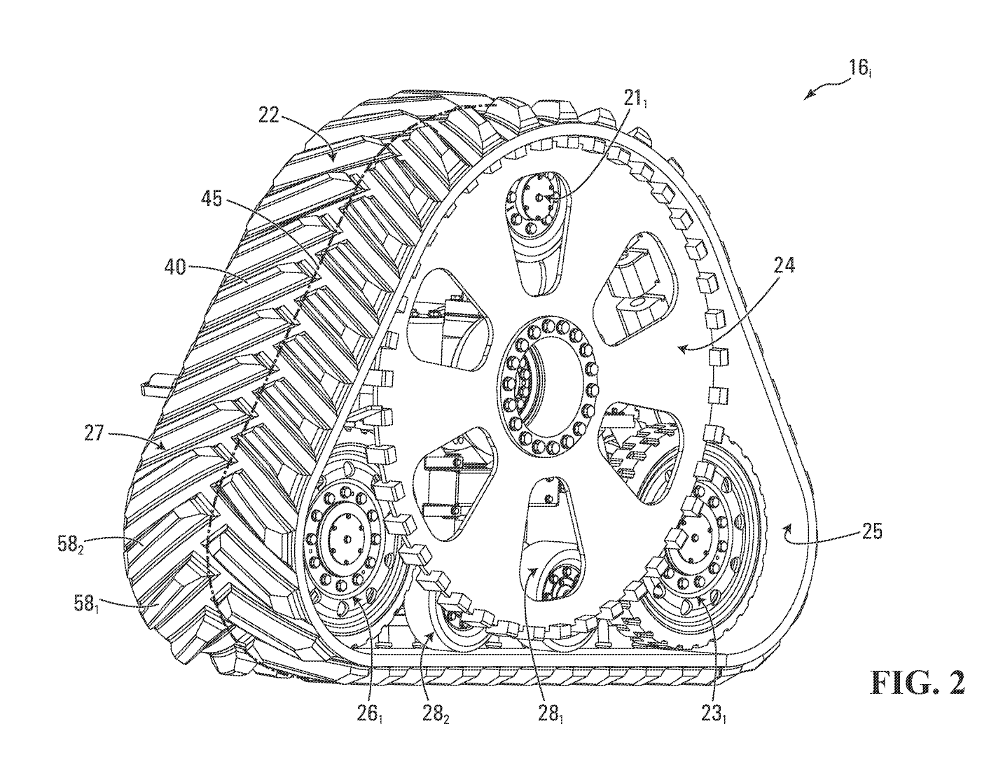

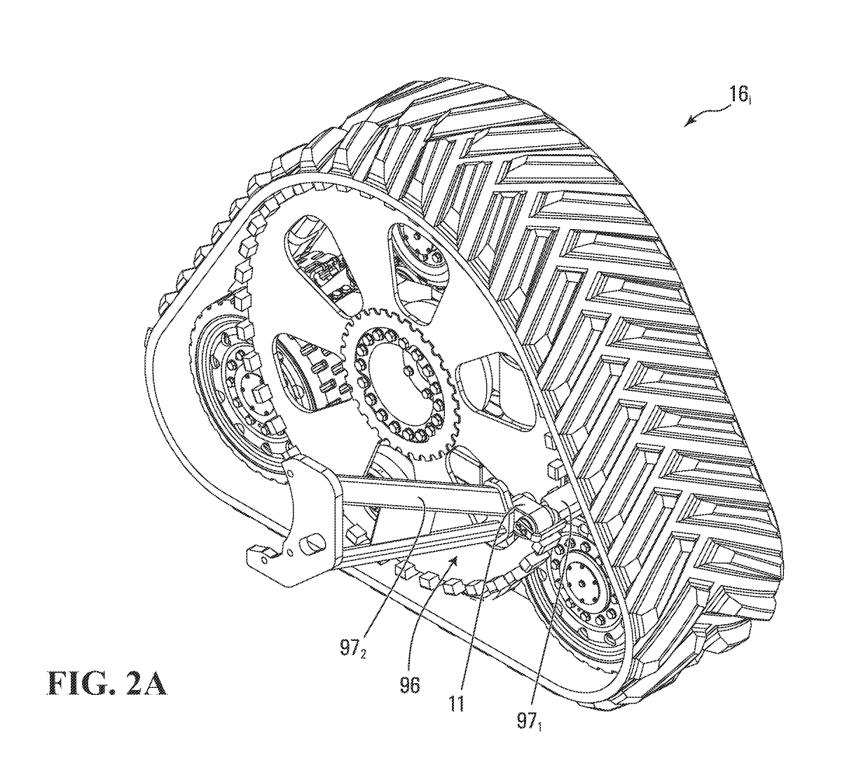

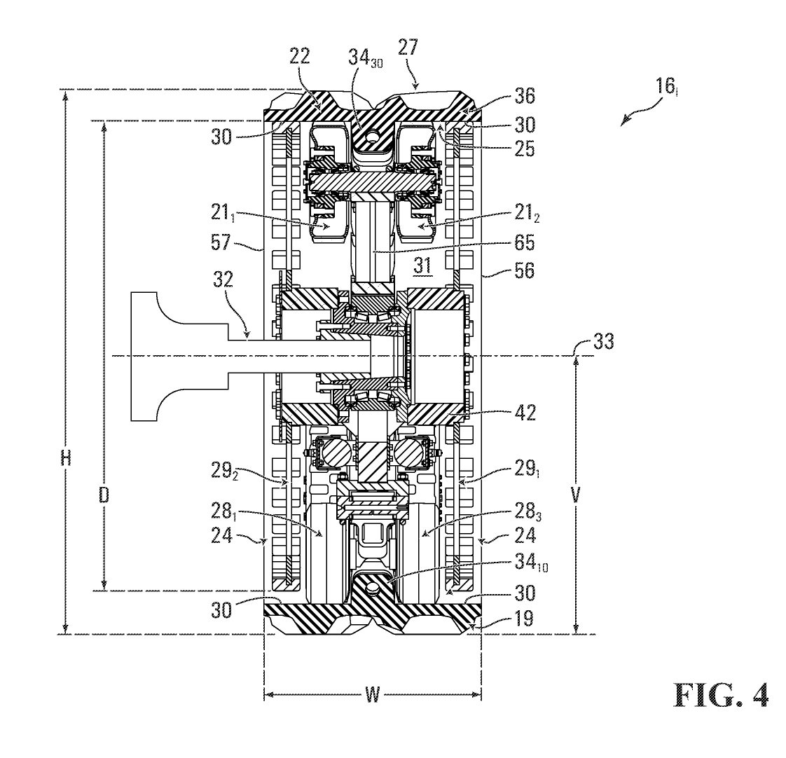

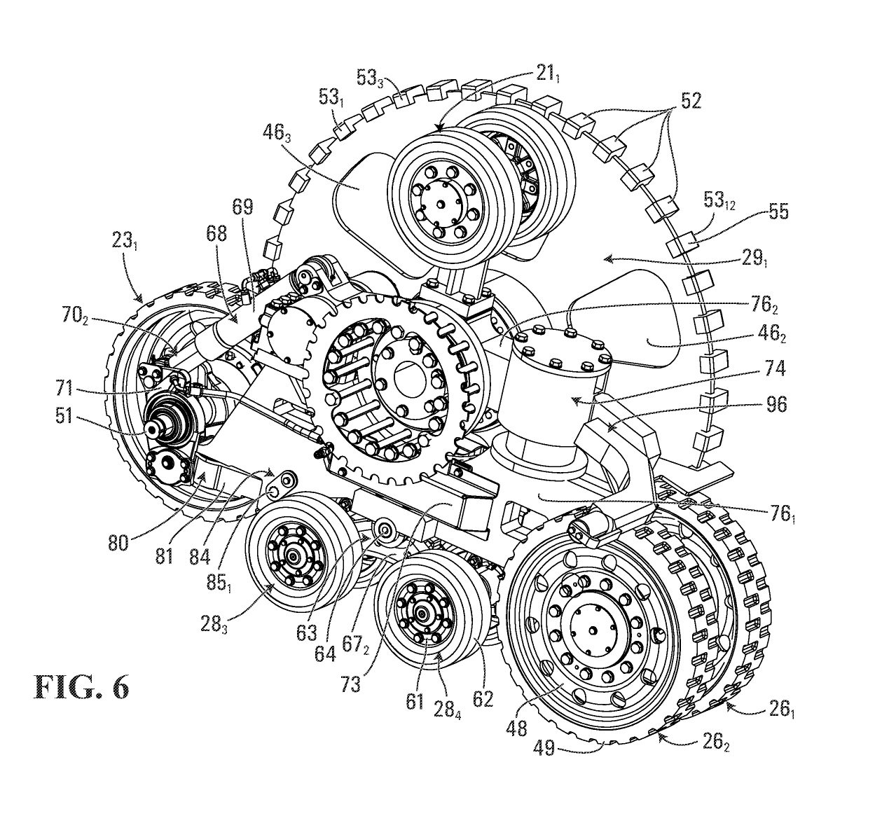

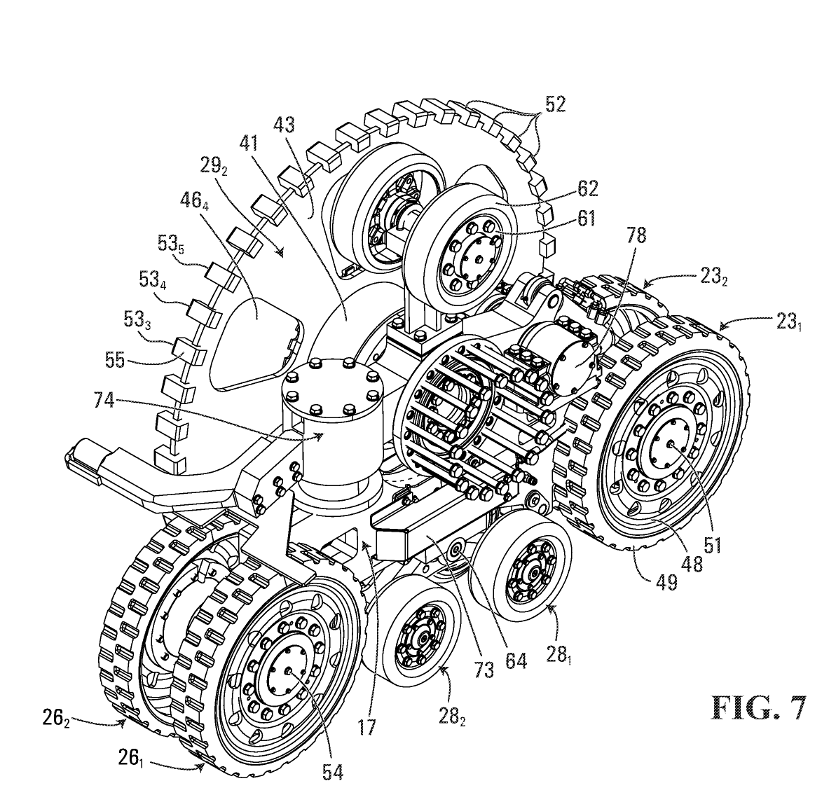

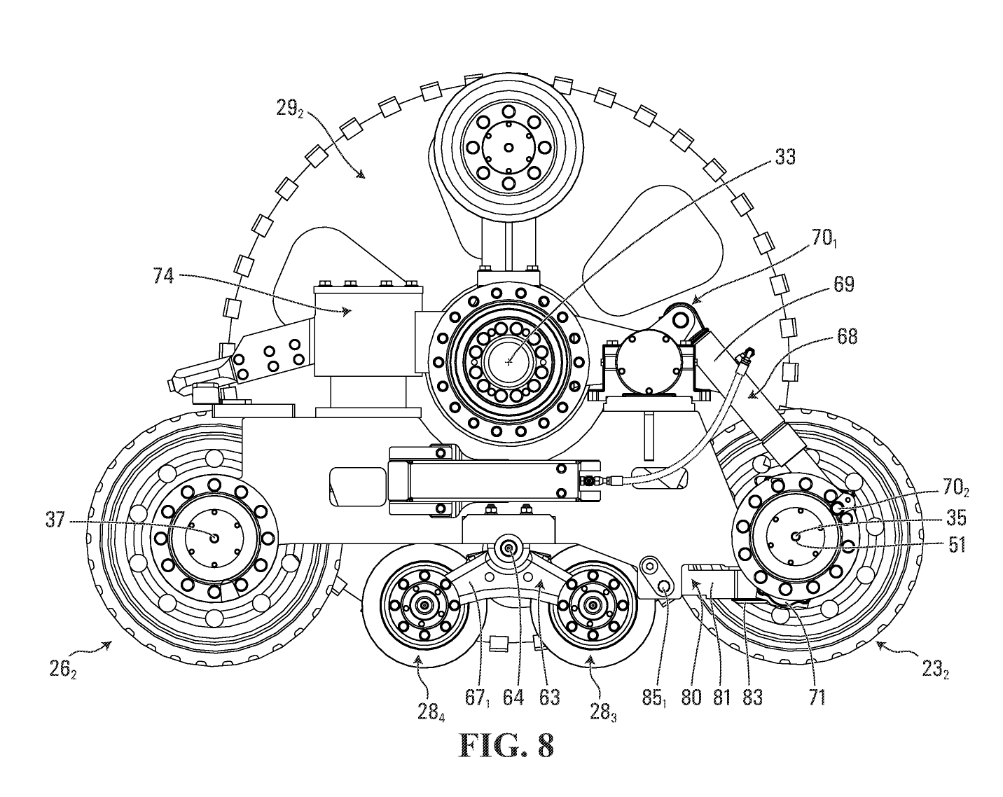

With additional reference to FIGS. 2 to 8, in this embodiment, each track assembly 16ᵢ comprises: a frame 17; a plurality of wheels, including a driver wheel 24 and a plurality of idler wheels, which includes front (i.e., leading) idler wheels 23₁, 23₂, rear (i.e., trailing) idler wheels 26₁, 26₂, lower roller wheels 28₁-28₄, and upper roller wheels 21₁, 21₂; and an endless track 22 disposed around these wheels. The driver wheel 24 is rotatable by power derived from the prime mover 14 to impart motion to the endless track 22 in order to propel the agricultural vehicle 10 on the ground. The idler wheels 23₁, 23₂, 26₁, 26₂, 28₁-28₄, 21₁, 21₂ do not convert power derived from the prime mover 14 to motive force, but are rather used to do at least one of supporting part of the weight of the agricultural vehicle 10 on the ground via the endless track 22, guiding the endless track 22 as it is driven by the driver wheel 24, and tensioning the endless track 22. As it is driven by the driver wheel 24, the endless track 22 engages the ground for traction.

The track assembly 16ᵢ has a longitudinal axis 59 (i.e., an axis generally parallel to a longitudinal axis of the agricultural vehicle 10) that defines a longitudinal direction of the track assembly 16ᵢ (i.e., a direction generally parallel to the longitudinal axis 59) and transversal directions of the track assembly 16ᵢ (i.e., directions transverse to the longitudinal axis 59), including a widthwise direction of the track assembly 16ᵢ (i.e., a lateral direction generally perpendicular to the longitudinal axis 59). The track assembly 16ᵢ has a length L, a width W, and a height H.

The track assembly 16ᵢ is mounted to an axle 32 of the agricultural vehicle 10. The axle 32 is a driven axle that is rotated by power derived from the prime mover 14 and delivered via the powertrain of the vehicle 10. More particularly, in this embodiment, the driver wheel 24 is mounted to the axle 32 of the agricultural vehicle 10. In this example, a hub 42 of the driver wheel 24 is mounted to the axle 32 via a bushing 47. In this case, the bushing 47 is a tapered bushing.

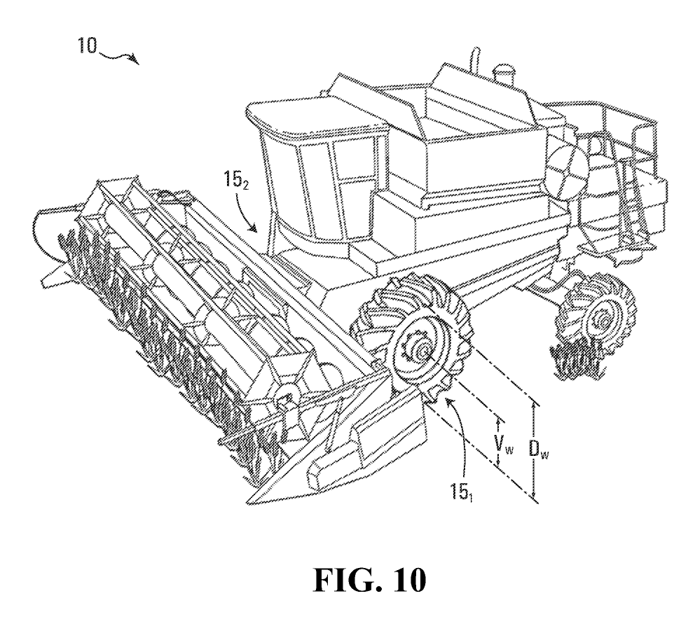

In this embodiment, the dimensions of the track assembly 16ᵢ allow it to be mounted in place of a ground-engaging wheel that may otherwise be mounted at a position of the track assembly 16ᵢ to propel the agricultural vehicle 10 on the ground. For example, as shown in FIG. 10, in some embodiments, the agricultural vehicle 10 may be propelled on the ground by front ground-engaging wheels 15₁, 15₂ instead of the track assemblies 16₁, 16₂. For instance, similar to but larger than the rear ground-engaging wheels 13₁, 13₂, each front ground-engaging wheels 15ᵢ may comprise a tire, which may be pneumatic or solid and made of rubber and/or other materials (e.g., agricultural or off-the-road (OTR) tires). When used, the ground-engaging wheel 15ᵢ is mounted to the axle 32 of the agricultural vehicle 10. In such embodiments, the track assembly 16ᵢ may be mounted in place of the ground-engaging wheel 15ᵢ by removing the ground-engaging wheel 15ᵢ and installing the track assembly 16ᵢ in its place. Basically, in such cases, the track assemblies 16₁, 16₂ may be used to convert the agricultural vehicle 10 from a purely wheeled vehicle into a tracked vehicle, thereby enhancing its traction and floatation on the ground. Of course, in some embodiments, the agricultural vehicle 10 may have been designed and manufactured as a tracked vehicle with the track assemblies 16₁, 16₂ already provided thereon.

The endless track 22 engages the ground to provide traction to the agricultural vehicle 10. More specifically, the endless track 22 comprises an inner side 25 and a ground-engaging outer side 27. The inner side 25 faces the wheels 24, 23₁, 23₂, 26₁, 26₂, 28₁-28₄, 21₁, 21₂ and defines an inner space of the track apparatus 16ᵢ in which these wheels rotate. The ground-engaging outer side 27 engages the ground for traction of the agricultural vehicle 10. The endless track 22 has a longitudinal axis 45 defining a longitudinal direction of the endless track 22 (i.e., a direction generally parallel to the longitudinal axis 45) and transversal directions of the endless track 22 (i.e., directions transverse to the longitudinal axis 45), including a widthwise direction of the endless track 22 (i.e., a lateral direction generally perpendicular to the longitudinal axis 45). The endless track 22 comprises an upper run 36 which extends from a front longitudinal end 88₁ of the track assembly 16ᵢ to a rear longitudinal end 88₂ of the track assembly 16ᵢ and above the drive wheel 24, and a lower run 19 which extends from the front longitudinal end 88₁ of the track assembly 16ᵢ to the rear longitudinal end 88₂ of the track assembly 16ᵢ and under the idler wheels 23₁, 23₂, 26₁, 26₂, 28₁-28₄.

More particularly, in this embodiment, the endless track 22 comprises an elastomeric body 39 underlying its inner side 25 and its ground-engaging outer side 27 and allowing the endless track 22 to elastically change in shape as it is in motion around the wheels 24, 23₁, 23₂, 28₁, 26₂, 28₁-28₄, 21₁, 21₂. In view of its underlying nature, the elastomeric body 39 can be referred to as a “carcass”. The carcass 39 is elastomeric in that it comprises elastomeric material. The elastomeric material of the carcass 39 can be any polymeric material with the property of elasticity. In this case, the elastomeric material of the carcass 39 includes rubber. Various rubber compounds may be used and, in some cases, different rubber compounds may be present in different areas of the carcass 39. In other cases, the elastomeric material of the carcass 39 may include another elastomer in addition to or instead of rubber (e.g., polyurethane elastomer). Also, in this embodiment, the carcass 39 comprises one or more reinforcements embedded in its elastomeric material. For example, one such reinforcement may be a layer of reinforcing cables (e.g., cords or wire ropes) that extend generally in the longitudinal direction of the endless track 22 to enhance its strength in tension along its longitudinal direction. Another example of a reinforcement is a layer of reinforcing fabric that comprises pliable material made usually by weaving, felting, or knitting natural or synthetic fibers (e.g., a ply of reinforcing woven fibers).

The ground-engaging outer side 27 of the endless track 22 comprises a tread pattern 40 to enhance traction on the ground. The tread pattern 40 comprises a plurality of a traction projections 58₁-58_{T} (sometimes referred to as “traction lugs”, “tread members” or “tread bars”) distributed on the ground-engaging outer side 27. In this embodiment, each of the traction projections 58₁-58_{T} has an elongated shape and is angled (i.e., defines an acute angle θ) relative to the longitudinal direction of the endless track 22. The traction projections 58₁-58_{T} may have various other shapes in other examples (e.g., curved shapes, shapes with straight parts and curved parts, etc.).

In this case, each traction projection 58ᵢ is an elastomeric traction projection in that it comprises elastomeric material. The elastomeric material of the traction projection 58ᵢ can be any polymeric material with suitable elasticity. More particularly, in this case, the elastomeric material of the traction projection 58ᵢ includes rubber. Various rubber compounds may be used and, in some cases, different rubber compounds may be present in different areas of the traction projection 58ᵢ. In other embodiments, the elastomeric material of the traction projection 58ᵢ may include another elastomer in addition to or instead of rubber.

The inner side 25 of the endless track 22 contacts the driver wheel 24 in order to cause motion of the endless track 22 around the wheels 24, 23₁, 23₂, 26₁, 26₂, 28₁-28₄, 21₁, 21₂. The inner side 25 also contacts the idler wheels 23₁, 23₂, 26₁, 26₂, 28₁-28₄, 21₁-21₂ which support part of the weight of the agricultural vehicle 10 on the ground via the endless track 22, guide the endless track 22 as it is driven by the driver wheel 24, and/or tension the endless track 22.

More particularly, in this embodiment, the inner side 25 comprises a friction drive surface 30 that frictionally engages the driver wheel 24 such that, as the driver wheel 24 rotates, friction between the friction drive surface 30 and the driver wheel 24 causes motion of the endless track 22 around the wheels 24, 23₁, 23₂, 26₁, 26₂, 28₁-28₄, 21₁, 21₂ to propel the agricultural vehicle 10 on the ground. The endless track 22 is tensioned around the wheels 24, 23₁, 23₂, 26₁, 26₂, 28₁-28₄, 21₁, 21₂ to create sufficient friction between the friction drive surface 30 and the driver wheel 24 to drive the track 22.

Also, in this embodiment, the inner side 45 of the endless track 22 comprises a plurality of inner wheel-contacting projections 34₁-34_{N} that are spaced apart along a longitudinal direction of the endless track 22 to contact at least some of the wheels 24, 23₁, 23₂, 26₁, 26₂, 28₁-28₄, 21₁, 21₂ and that are used to do at least one of driving (i.e., imparting motion to) the track 22 and guiding the track 22. In that sense, the wheel-contacting projections 34₁-34_{N} can be referred to as “drive/guide projections”, meaning that each drive/guide projection is used to do at least one of driving the track 22 and guiding the track 22. More particularly, in this embodiment, the drive/guide projections 34₁-34_{N} are guide projections used to guide the endless track 22 as it is driven by the driver wheel 24 in order to help prevent undesired lateral movement or detracking of the track 22. To that end, the guide projections 34₁-34_{N} interact with the idler wheel 23₁, 23₂, 26₁, 26₂, 28₁-28₄, 21₁, 21₂ in order to guide the track 22 as it is driven by the driver wheel 24.

In this case, each guide projection 34ᵢ is an elastomeric guide projection in that it comprises elastomeric material. The elastomeric material of the guide projection 34ᵢ can be any polymeric material with suitable elasticity. More particularly, in this case, the elastomeric material of the guide projection 34ᵢ includes rubber. Various rubber compounds may be used and, in some cases, different rubber compounds may be present in different areas of the guide projection 34ᵢ. In other cases, the elastomeric material of the guide projection 34ᵢ may include another elastomer in addition to or instead of rubber.

The driver wheel 24 is rotatable by power derived from the prime mover 14 to impart motion to the endless track 22. The driver wheel 24 thus rotates when the axle 32 of the agricultural vehicle 10 rotates. More particularly, in this embodiment, the driver wheel 24 is mounted to the axle 32 of the agricultural vehicle 10. The driver wheel 24 has an axis of rotation 33 which is defined by the axle 32 of the agricultural vehicle 10. An axis of rotation of the axle 32, which in this case corresponds to the axis of rotation 33 of the driver wheel 24, is located between respective axes of rotation 35, 37 of the front idler wheels 23₁, 23₂ and the rear idler wheels 26₁, 26₂ in the longitudinal direction of the track assembly 16ᵢ. The driver wheel 24 contacts the upper run 36 of the endless track 22 and is vertically spaced apart from the lower run 19 of the endless track 22.

In this embodiment, the driver wheel 24 is large. Specifically, in this embodiment, the driver wheel 24 has a diameter D defining a circular area that occupies a majority of an internal cross-sectional area of the track assembly 16ᵢ perpendicular to the axis of rotation 33 of the driver wheel 24 and delimited by the inner side 25 of the endless track 22. That is, the circular area defined by the diameter D of the driver wheel 24 occupies a portion of the internal cross-sectional area of the track assembly 16ᵢ that is greater than a portion of the internal cross-sectional area of the track assembly 16ᵢ occupied by any other one of the wheels 23₁, 23₂, 26₁, 26₂, 28₁-28₄, 21₁, 21₂ of the track assembly 16ᵢ. In this example, the circular area defined by the diameter D of the driver wheel 24 occupies more than half of the internal cross-sectional area of the track assembly 16ᵢ.

More particularly, in this embodiment, the driver wheel 24 occupies most of the height H of the track assembly 16ᵢ. That is, the diameter D of the driver wheel 24 corresponds to more than half, in some cases at least two-thirds, in some cases at least three-quarters, and in some cases at least four-fifths of the height H of the track assembly 16ᵢ. In this case, the diameter D of the driver wheel 24 corresponds to more than 80% of the height H of the track apparatus 16ᵢ. Also, in this embodiment, the driver wheel 24 occupies most of the length L of the track assembly 16ᵢ. That is, the diameter D of the driver wheel 24 corresponds to more than half, in some cases at least 55%, in some cases at least 60%, and in some cases at least 65% of the length L of the track assembly 16ᵢ. In fact, in this embodiment, the diameter D of the driver wheel 24 is sufficiently large that the driver wheel 24 overlaps part of each of the idler wheels 23₁, 23₂, 26₁, 26₂, 28₁-28₄.

The driver wheel 24 contacts the endless track 22 along an arc of contact that subtends an angle β. This angle β, which may be referred to as an “angle of wrap”, can take on various values. For example, in some embodiments, the angle of wrap β may be of at least 100°, in some cases at least 110°, and in some cases at least 120°. In this embodiment, the angle of wrap β is about 130°.

By virtue of its large size, the driver wheel 24 can enhance its driving efficiency by contacting the endless track 22 along a relatively large part of its periphery.

Also, in embodiments where the track assembly 16ᵢ is used in place of a ground-engaging wheel 15ᵢ on which the agricultural vehicle 10 could be propelled on the ground, the diameter D of the driver wheel 24 may be comparable to a diameter D_{w} of the ground-engaging wheel 15ᵢ. For example, the diameter D of the driver wheel 24 may correspond to more than 75%, in some cases at least 80%, in some cases at least 85%, and in some cases at least 90% of the diameter D_{w} of the ground-engaging wheel 15ᵢ. This may facilitate rapid and stable rotation of the driver wheel 24 by the axle 32 of the agricultural vehicle 10.

The track assembly 16ᵢ may be dimensioned such that a vertical distance V between the axis of rotation of the axle 32 of the agricultural vehicle 10 and the ground when the track assembly 16ᵢ is mounted to the axle 32 substantially corresponds to a vertical distance V_{w} between the axis of rotation of the axle 32 of the agricultural vehicle 10 and the ground when the ground-engaging wheel 15ᵢ, which could be used in place of the track assembly 16ᵢ, is mounted to the axle 32. Since in this case the axis of rotation 33 of the driver wheel 24 and the axis of rotation of the ground-engaging wheel 15ᵢ would generally coincide with the axis of rotation of the axle 32 of the agricultural vehicle 10, the vertical distance V and the vertical distance V_{w} could also be respectively measured between the axis of rotation 33 of the driver wheel 24 and the ground and between the axis of rotation of the ground-engaging wheel 15ᵢ and the ground. Basically, the track assembly 16ᵢ may be dimensioned such that, when the track assembly 16ᵢ is mounted to the axle 32, the axle 32 lies at a level above the ground which is substantially maintained to that at which the axle 32 lies when the ground-engaging wheel 15ᵢ is mounted to the axle 32. This allows the agricultural vehicle 10 to substantially remain at the same height relative to the ground as if it was on the ground-engaging wheel 15ᵢ, which may allow more stable motion of the agricultural vehicle 10, especially at higher speed.

For example, in some embodiments, a ratio V/V_{w} of the vertical distance V between the axis of rotation of the axle 32 of the agricultural vehicle 10 and the ground when the track assembly 16ᵢ is mounted to the axle 32 and the vertical distance V_{w} between the axis of rotation of the axle 32 of the agricultural vehicle 10 and the ground when the ground-engaging wheel 15ᵢ is mounted to the axle 32 may be between 0.9 and 1.1, in some cases between 0.925 and 1.075, in some cases between 0.95 and 1.05, and in some cases between 0.975 and 1.025.

The ground-engaging wheel 15ᵢ is one that is specified for the agricultural vehicle 10 (e.g., by a manufacturer of the agricultural vehicle 10 and/or by a provider of ground-engaging wheels for agricultural vehicles such as the agricultural vehicle 10). When two or more ground-engaging wheels having different sizes, i.e., different diameters, are specified as being usable on the agricultural vehicle 10, the ground-engaging wheel 15ᵢ to be considered for the values of the diameter D_{w} and the vertical distance V_{w} referred to herein can be taken as that ground-engaging wheel whose diameter corresponds to or is as close as possible to an average of the different diameters of the ground-engaging wheels specified as being usable on the agricultural vehicle 10.

As it rotates, the driver wheel 24 contacts the upper run 36 of the endless track 22 to impart motion to the endless track 22. To that end, in this embodiment, the driver wheel 24 comprises a friction drive surface 50 that frictionally engages the friction drive surface 30 of the endless track 22 such that, as the driver wheel 24 rotates, friction between the friction drive surface 30 of the endless track 22 and the friction drive surface 50 of the driver wheel 24 causes motion of the endless track 22 around the wheels 24, 23₁, 23₂, 26₁, 26₂, 28₁-28₄, 21₁, 21₂ to propel the agricultural vehicle 10 on the ground.

More particularly, in this embodiment, the driver wheel 24 comprises a first driver wheel portion 29₁ and a second driver wheel portion 29₂ that are spaced apart along the axis of rotation 33 of the driver wheel 24 to define a space 31 therebetween. In this case, the driver wheel portions 29₁, 29₂ are two (2) driver wheel members that are separate from one another. In other cases, the driver wheel portions 29₁, 29₂ may be integral with one another.

Each driver wheel member 29ᵢ comprises a hub 41 mountable to the axle 32 of the agricultural vehicle 10 and a wheel body 43 extending radially from the hub 41. The hubs 41 of the driver wheel members 29₁, 29₂ constitute the hub 42 of the driver wheel 24. In this example, the wheel body 43 is substantially thinner than the hub 41 in order to reduce weight of the driver wheel member 29ᵢ. Specifically, the wheel body 43 has a thickness in a direction generally parallel to the axis of rotation 33 of the driver wheel 24 that is substantially less than a dimension of the hub 41 in that same direction. Also, in this example, the wheel body 43 comprises a plurality of apertures 46₁-46₆ to further reduce the weight of the driver wheel member 29ᵢ.

The driver wheel member 29ᵢ has a periphery contacting the inner side 25 of the endless track 22 to impart motion to the endless track 22. In this embodiment, the periphery of the driver wheel member 29ᵢ comprises a friction drive surface 52 that frictionally engages the friction drive surface 30 of the endless track 22 in order to frictionally drive the endless track 22. Thus, in this case, the friction drive surface 52 of the driver wheel member 29₁ and the friction drive surface 52 of the driver wheel member 29₂ constitute the friction drive surface 50 of the driver wheel 24.

In this embodiment, the periphery of the driver wheel member 29ᵢ comprises a plurality of driving protrusions (e.g., driving fingers) 53₁-53_{N} spaced apart circumferentially from one another. Adjacent ones of the driving protrusions 53₁-53_{N} can be viewed as defining openings (e.g., slots) in the periphery of the driver wheel member 29ᵢ. In this example, the driving protrusions 53₁-53_{N} are shaped as blocks. The driving protrusions 53₁-53_{N} may have various other shapes in other examples.

Each of the driving protrusions 53₁-53_{N} has a friction drive surface 55 that frictionally engages the friction drive surface 30 of the endless track 22 in order to frictionally drive the endless track 22. Thus, in this case, the friction drive surface 52 of the driver wheel member 29ᵢ is constituted by the friction drive surface 55 of each of the driving protrusions 53₁-53_{N}. In other words, in this case, the friction drive surfaces 55 of the driving protrusions 53₁-53_{N} and the openings therebetween are such that the friction drive surface 52 of the driver wheel member 29ᵢ is a “discontinuous” friction drive surface.

In this example, each of the driving protrusions 53₁-53_{N} has a dimension in a direction generally parallel to the axis of rotation 33 of the driver wheel 24 that is substantially greater than the dimension of wheel body 43 in that same direction. This can allow the friction drive surface 55 of each of the driving protrusions 53₁-53_{N}, and therefore the friction drive surface 52 of the driver wheel member 29ᵢ, to be greater in size while minimizing the weight of the driver wheel member 29ᵢ. Also, the driving protrusions 53₁-53_{N} provide a large number of edges that can help to “clean” the friction drive surface 30 of the track 22 and thus enhance its frictional engagement with the driver wheel 24.

The driver wheel member 29ᵢ may be constructed in various ways and using various materials. In this embodiment, the driver wheel member 29ᵢ is a one-piece driver wheel member made by casting metallic material (e.g., steel) into shape. In other embodiments, the driver wheel member 29ᵢ may be a multi-piece driver wheel member and/or may be made using other materials (e.g., polymers, composites) and/or other manufacturing processes. For example, instead of being integral with the wheel body 43, in some embodiments, each of the driving protrusions 53₁-53_{N} may be removably mounted to wheel body 43 (e.g., via one or more suitable fasteners such as a threaded fastener, a clip, a pin, etc.) so as to be removable from the wheel body 43 and replaceable by another driving protrusion. As another example, in some embodiments, each driving protrusion 53ᵢ may comprise a removable portion which is removably mounted to a remainder of that driving protrusion (e.g., via one or more suitable fasteners, such as a threaded fastener, a clip, a pin, etc.). For instance, the removable portion may a wear pad or other wearable portion which is made of the same material as the remainder of the driving protrusion 53ᵢ or a different material (e.g., rubber) and which comprises the friction drive surface 55 of the driving protrusion 53ᵢ.

The driver wheel member 29ᵢ may be configured in various other ways to frictionally drive the endless track 22. For example, in some embodiments, instead of comprising the driving protrusions 53₁-53_{N} and the openings therebetween that form a “discontinuous” surface, the periphery of the driver wheel member 29ᵢ may form a continuous surface. As another example, in some embodiments, the periphery of the driver wheel member 29ᵢ may comprise material enhancing frictional contact between the driver wheel member 29ᵢ and the endless track 22. For instance, in some embodiments, such material may be polymeric material such as rubber or some other elastomer, or any other material having a high coefficient of friction with the elastomeric material 39 of the track 22.

In this embodiment, each of the frame 17 and the idler wheels 23₁, 23₂, 26₁, 26₂, 28₁-28₄, 21₁, 21₂ is positioned laterally between the driver wheel members 29₁, 29₂. Specifically, at least part of each of the frame 17 and the idler wheels 23₁, 23₂, 26₁, 26₂, 28₁-28₄, 21₁, 21₂ is located in the space 31 between the driver wheel members 29₁, 29₂. The driver wheel member 29₁, which is positioned between an outboard lateral edge 56 of the track 22 (i.e., a lateral edge of the track 22 farthest from a centerline of the agricultural vehicle 10) and each of the frame 17 and the wheels 23₁, 23₂, 26₁, 26₂, 28₁-28₄, 21₁, 21₂, can thus be viewed as an “outboard” driver wheel member, while the driver wheel member 29₂, which is positioned between an inboard lateral edge 57 of the track 22 (i.e., a lateral edge of the track 22 nearest to the centerline of the agricultural vehicle 10) and each of the frame 17 and the wheels 23₁, 23₂, 26₁, 26₂, 28₁-28₄, 21₁, 21₂, can thus be viewed as an “inboard” driver wheel member.

The driver wheel 24 can thus efficiently drive the endless track 22. In particular, the driver wheel 24 allows the endless track 22 to be driven at relatively high speed. In turn, this enables the agricultural vehicle 10 to travel on the ground at relatively high speed.

For example, in embodiments in which the track assemblies 16₁, 16₂ are used in place of ground-engaging wheels 15₁, 15₂ on which the agricultural vehicle 10 can be propelled on the ground, the track assemblies 16₁, 16₂ may enable the agricultural vehicle 10 to travel on the ground at an operational speed of up to at least 80%, in some cases up to at least 85%, in some cases up to at least 90%, and in some cases up to at least 95% of a maximum operational speed S_{w} of the agricultural vehicle 10 when propelled on the ground by the ground-engaging wheels 15₁, 15₂. In other words, a ratio S/S_{w} of a maximum operational speed S of the agricultural vehicle 10 when propelled on the ground by the track assemblies 16₁, 16₂ to the maximum operational speed S_{w} of the agricultural vehicle 10 when propelled on the ground by the ground-engaging wheels 15₁, 15₂ may be at least 0.8, in some cases at least 0.85, in some cases at least 0.9, and in some cases at least 0.95, or more (e.g., the operational speed of the agricultural vehicle 10 when equipped with the track assemblies 16₁, 16₂ may reach 100% of the maximum operational speed of the agricultural vehicle 10 when equipped with the ground-engaging wheels 15₁, 15₂).

The maximum operational speed S_{w} of the agricultural vehicle 10 when propelled on the ground by the ground-engaging wheels 15₁, 15₂ refers to a maximum speed of the agricultural vehicle 10 that is sustainable in steady-state during normal operation of the agricultural vehicle 10 when propelled on the ground by the ground-engaging wheels 15₁, 15₂. For instance, in some cases, this maximum operational speed S_{w} may be indicated as a recommended maximal speed by a provider (e.g., in specifications) of the agricultural vehicle 10 and/or regulated by a speed controller of the agricultural vehicle 10. In other cases, this maximum operational speed S_{w} may be determined by conducting a test in which the agricultural vehicle 10, equipped with the ground-engaging wheels 15₁, 15₂, is driven on the ground to evaluate a maximum speed that can be reached in a straight line.

Similarly, the maximum operational speed S of the agricultural vehicle 10 when propelled on the ground by the track assemblies 16₁, 16₂ refers to a maximum speed of the agricultural vehicle 10 that is sustainable in steady-state during normal operation of the agricultural vehicle 10 when propelled on the ground by the track assemblies 16₁, 16₂. For instance, in some cases, this maximum operational speed S may be indicated as a recommended maximal speed by a provider (e.g., in specifications) of the track assemblies 16₁, 16₂ and/or of the agricultural vehicle 10, and/or may be regulated by a speed controller of the agricultural vehicle 10. In other cases, this maximum operational speed S may be determined by conducting a test in which the agricultural vehicle 10, equipped with the track assemblies 16₁, 16₂, is driven on the ground to evaluate a maximum speed that can be reached in a straight line.

The ratio S/S_{w} of the maximum operational speed S of the agricultural vehicle 10 when propelled on the ground by the track assemblies 16₁, 16₂ to the maximum operational speed S_{w} of the agricultural vehicle 10 when propelled on the ground by the ground-engaging wheels 15₁, 15₂ may also be evaluated based on geometrical considerations. For example, in this embodiment, since the driver wheel 24 is mounted to the axle 32 of the agricultural vehicle 10, the ratio S/S_{w} may be evaluated as the ratio of the diameter D of the driver wheel 24 to the diameter D_{w} of the ground-engaging wheel 15ᵢ.

The front idler wheels 23₁, 23₂ and the rear idler wheels 26₁, 26₂ can support part of the weight of the agricultural vehicle 10 via the endless track 22 and guide the endless track 22 and maintain it under tension as it is driven by the driver wheel 24. In this embodiment, each of the idler wheels 23₁, 23₂, 26₁, 26₂ comprises a wheel body 48 made of rigid material (e.g., steel or other metal) and a peripheral portion 49 made of elastomeric material (e.g., rubber) that enhances its grip on the inner side 25 of the endless track 22. The front idler wheels 23₁, 23₂ are rotatable about an axle 51 and the rear idler wheels 23₁, 23₂ are rotatable about an axle 54. In other embodiments, each of the idler wheels 23₁, 23₂, 26₁, 26₂ may be rotatable about a different axle and/or constructed in various other manners and/or using various other materials.

The front idler wheels 23₁, 23₂ are spaced apart laterally from one another to define a space therebetween. Similarly, the rear idler wheels 26₁, 26₂ are spaced apart laterally from one another to define a space therebetween. As the endless track 22 is in motion, its guide lugs 34₁-34_{N} pass in the space between the front idler wheels 23₁, 23₂ and in the space between the rear idler wheels 26₁, 26₂ and, by being so constrained, help to guide the motion of the endless track 22 to prevent undesired lateral movement or detracking of the track 22.

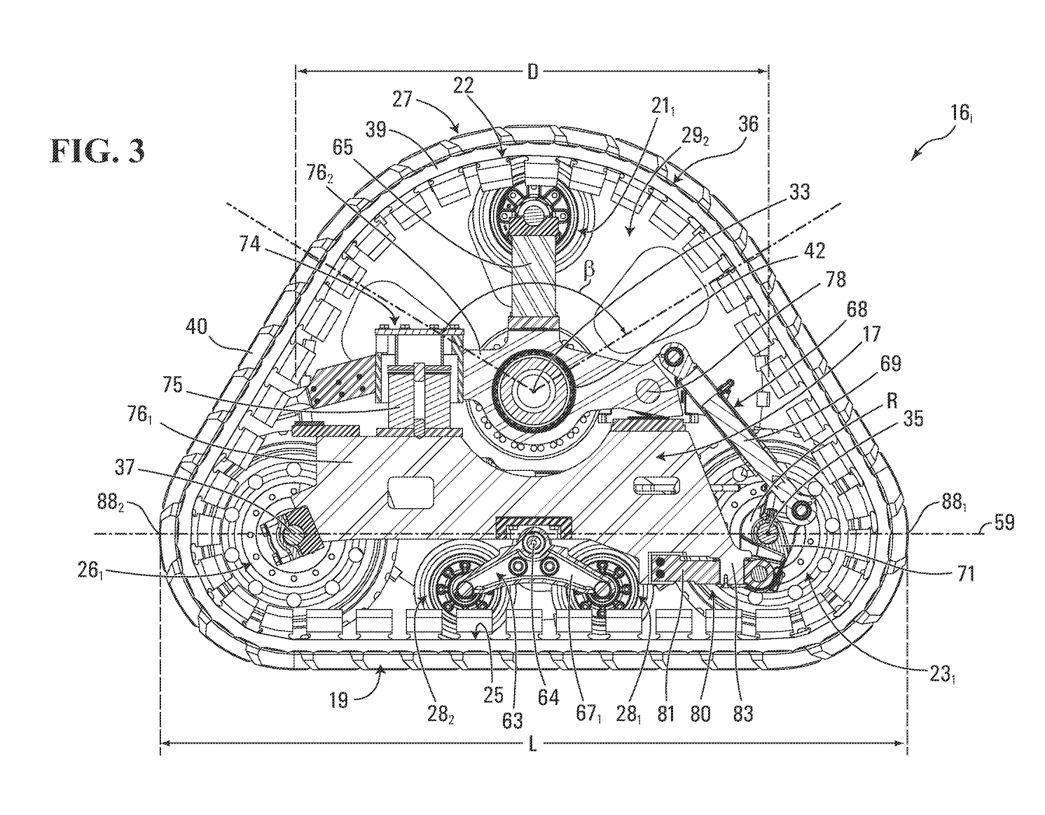

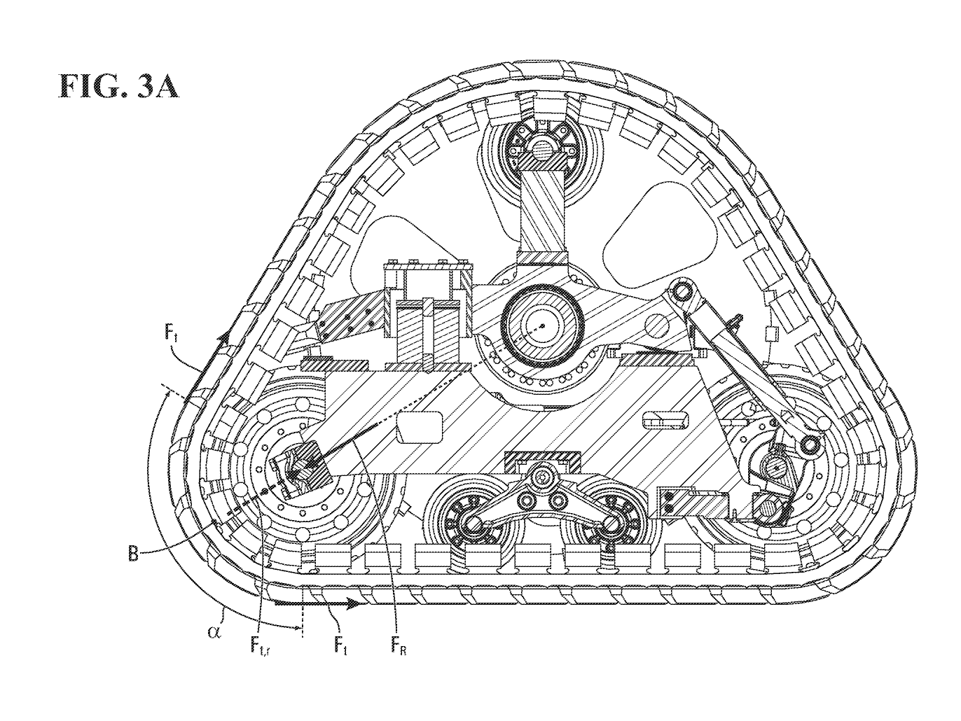

In this embodiment, as shown in FIG. 3A, the track assembly 16ᵢ is configured such that a resultant tension force F_{t,r} from the endless track 22 at the rear idler wheel 26ᵢ is oriented to intersect the axle 32 of the agricultural vehicle 10. This can help to reduce a tendency of the track assembly 16ᵢ to pivot about the axle 32 during use. The resultant tension force F_{t,r} is a resultant of tension force components Fₜ exerted by the endless track 22 on the rear idler wheel 26ᵢ. The tension force components Fₜ at the rear idler wheel 26ᵢ are related to the tension in the endless track 22 and a traction force due to traction of the endless track 22 on the ground. A reaction F_{R} to the resultant tension force F_{t,r} at the rear idler wheel 26ᵢ is opposite to the resultant tension force F_{t,r} and thus is also oriented to intersect the axle 32 of the agricultural vehicle 10. Basically, in this case, a line passing through the axis of rotation of the axle 32 of the agricultural vehicle 10 and the axis of rotation 37 of the rear idler wheel 26ᵢ bisects an angle of wrap a of the endless track 22 on the rear idler wheel 26ᵢ. In other words, in this case, this bisecting line would intersect the endless track 22 at a midpoint B of an arc of contact between the endless track 22 and the rear idler wheel 26ᵢ that is subtended by the angle of wrap α.

The bogie wheels 28₁-28₄ and the upper roller wheels 21₁, 21₂ guide the endless track 22 as it is driven by the driver wheel 24. In this embodiment, each of the bogie wheels 28₁-28₄ and the upper roller wheels 21₁, 21₂ comprises a wheel body 61 made of rigid material (e.g., steel or other metal) and a peripheral portion 62 made of elastomeric material (e.g., rubber) that enhances its grip on the inner side 25 of the endless track 22. The bogie wheels 28₁-28₄ and the upper roller wheels 21₁, 21₂ may be constructed in various other manners and/or using various other materials in other embodiments.

The bogie wheels 28₁-28₄ roll on the lower run 19 of the endless track 22 to apply it on the ground for traction. In this embodiment, the bogie wheels 28₁-28₄ are mounted to a wheel-carrying structure 63 that is pivotally mounted to the frame 17 at a pivot 64. In this example, the bogie wheels 28₁, 28₂ are mounted to a first structural member 67₁ of the wheel-carrying structure 63 to form a first “tandem”, while the bogie wheels 28₃, 28₄ are mounted to a second structural member 67₂ of the wheel-carrying structure 63 to form a second “tandem”. With this arrangement, the structural members 67₁, 67₂ of the wheel-carrying member 63 can independently pivot relative to the frame 17 to allow the bogie wheels 28₁-28₄ to conform to changes in ground level or objects (e.g., rocks) on the ground. The bogie wheels 28₁-28₄ may be arranged in various other manners in other embodiments.

The upper roller wheels 21₁, 21₂ roll on the upper run 36 of the endless track 22 to support a central portion of the upper run 36 that is not in contact with the driver wheel 24. This helps to maintain the upper run 36 of the track 22 in a shape that facilitates frictional contact between the driver wheel 24 and the track 22. In this embodiment, the upper roller wheels 21₁, 21₂ are mounted to a wheel-carrying arm 65 of the frame 17 that extends upwardly from a region of the hub 42 of the driver wheel 24. The upper roller wheels 21₁, 21₂ may be arranged in various other ways in other embodiments.

In this embodiment, by being mounted to the agricultural vehicle 10 at the axle 32, the track assembly 16ᵢ is pivotable relative to a remainder of the agricultural vehicle 10 about a pivot axis which generally corresponds to the axis of rotation of the axle 32. In this case, a bearing 98 is associated a pivot movement of the track assembly 16ᵢ about the axis of rotation of the axle 32.

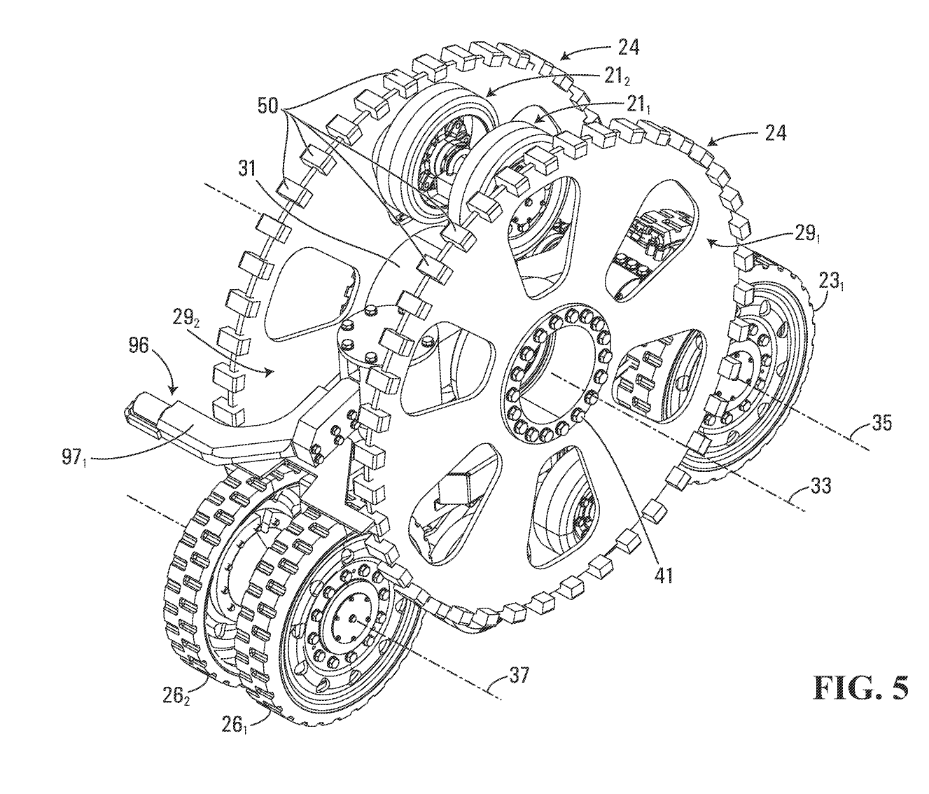

As shown in FIGS. 2A and 5, in this embodiment, an anti-rotation connector 96 is connected between the frame 17 of the track assembly 16ᵢ and the frame 12 of the agricultural vehicle 10 in order to limit the pivot movement of the track assembly 16ᵢ. The anti-rotation connector 96 comprises a first portion 97₁ which is connected to the frame 17 of the track assembly 16ᵢ and a second portion 97₂ which is connected to the frame 12 of the agricultural vehicle 10. In this example, these portions of the anti-rotation connector 96 are linked to one another such that the first portion 97₁ of the anti-rotation connector 96 is movable relative to the second portion 97₂ of the anti-rotation connector 96, which is fixed to the frame 12 of the vehicle 10. In this case, the first portion 97₁ of the anti-rotation connector 96 comprises an L-shaped arm and the second portion 97₂ of the anti-rotation connector 96 comprises a pair of arms leading to a plate that is fixed (e.g., fastened) to the frame 12 of the vehicle 10. Here, an end part of the first portion 97₁ of the anti-rotation connector 96 is linked to an end part of the portion 97₂ of the anti-rotation connector 96 by an elastic element 11. When the end part of the first portion 97₁ of the anti-rotation connector 96 and the end part of the second portion 97₂ of the anti-rotation connector 96 move away from one another due to the pivot movement of the track assembly 16ᵢ, the elastic element 11 elastically deforms (i.e., stretches in this case) and urges these end parts of the portions 97₁, 97₂ of the anti-rotation connector 96 back towards one another, thereby limiting the pivot movement of the track assembly 16ᵢ. In this example, the elastic element 11 is an elastomeric band (e.g., a rubber band) wrapped around the end parts of the portions 97₁, 97₂ of the anti-rotation connector 96. In other examples, the elastic element 11 may be a coil spring (e.g., a metallic or polymeric coil spring), a leaf spring, a gas spring (i.e., gas contained in a cylinder and variably compressed by a piston), or any other elastic object that deforms under stress and recovers its original configuration when the stress is released.

In this embodiment, the track assembly 16ᵢ comprises a tensioning system 68 for maintaining the endless track 22 in tension. In this example, the tensioning system 68 is connected between the frame 17 and the front idler wheels 23₁, 23₂ to urge the front idler wheels 23₁, 23₂ in a direction to maintain the endless track 22 in tension. The tensioning system 68 is positioned laterally between the driver wheel members 29₁, 29₂.

More particularly, in this embodiment, the tensioning system 68 is a pressure-based tensioning system, i.e., a hydraulic or pneumatic tensioning system, which comprises a piston-cylinder arrangement 69 connected to a fluid reservoir 73 (e.g., a hydraulic piston-cylinder arrangement connected to a hydraulic accumulator). The piston-cylinder arrangement 69 has a first end portion 70₁ connected to the frame 17 and a second end portion 70₂ connected to a link 71 mounted to the axle 51 of the front idler wheels 23₁, 23₂. In this example, the end portion 70₂ of the piston-cylinder arrangement 69 is connected to the link 71 at a location above the axis of rotation 35 of the front idler wheels 23₁, 23₂. This may provide a greater clearance between the piston-cylinder arrangement 69 and the inner side 25 of the endless track 22.

A piston of the piston-cylinder arrangement 69 is movable relative to a cylinder of the piston-cylinder arrangement 69 between an extended position and a retracted position. Pressure of a fluid inside the piston-cylinder arrangement 69 urges the piston towards its extended position. As a result, the piston pulls on the link 71 which biases the axle 51 and the front idler wheels 23₁, 23₂ mounted thereon away from the rear idler wheels 26₁, 26₂, thereby maintaining the track 22 in tension. The tensioning system 68 allows tension in the track 22 to be manually adjusted to a desired level before use and remains active during use to maintain the tension in the track 22 at the desired level.

The tensioning system 68 may be constructed in various other ways and/or using various other materials in other embodiments. For example, in some embodiments, the tensioning system 68 may comprise a coil spring or any other elastic object that deforms under stress and recovers its original configuration when the stress is released.

In this embodiment, the track assembly 16ᵢ comprises a suspension 74 for improving ride quality on the ground and/or absorbing shocks experienced by the track assembly 16ᵢ. The suspension 74 comprises an elastic element 75 that is elastically deformable to allow movement of a first portion 76₁ of the frame 17 relative to a second portion 76₂ of the frame 17. The elastic element 75, may be a coil spring (e.g., a metallic or polymeric coil spring), a leaf spring, an elastomeric member (e.g., a rubber spring such as a single or double convolution rubber spring), a gas spring (i.e., gas contained in a cylinder and variably compressed by a piston), or any other elastic object that deforms under stress and recovers its original configuration when the stress is released. The suspension 74 is positioned laterally between the driver wheel members 29₁, 29₂.

More particularly, in this embodiment, the first portion 76₁ of the frame 17 is a lower portion of the frame 17 that carries the idler wheels 23₁, 23₂, 26₁, 26₂ and the bogie wheels 28₁-28₄. The second portion 76₂ of the frame 17 is an upper portion of the frame 17 that is mounted over the hub 42 of the driver wheel 24 and carries the upper roller wheels 21₁, 21₂. The lower and upper portions 76₁, 76₂ of the frame 17 are, interconnected via the elastic element 75 and via a pivot 78 which allows them to pivot relative to one another. Thus, when the track assembly 16ᵢ moves on the ground, the lower portion 76₁ of the frame 17 may pivot relative to the upper portion 76₂ of the frame 17, thereby causing deformation (i.e., compression or extension) of the elastic element 75. Upon release of the stress to which it is subjected, the elastic element 75 may recover its original configuration, biasing the lower and upper portions 76₁, 76₂ of the frame 17 back to their respective original relative positions.

The suspension 74 may be constructed in various other ways and/or using various other materials in other embodiments. For example, in some embodiments, the suspension 74 may comprise a damper (i.e., a shock absorber), such as a hydraulic or pneumatic damper, a frictional damper (based on dry or fluid friction) or any other type of damper, to dampen shocks experienced by the track assembly 16ᵢ, to a greater extent than the elastic element 75.

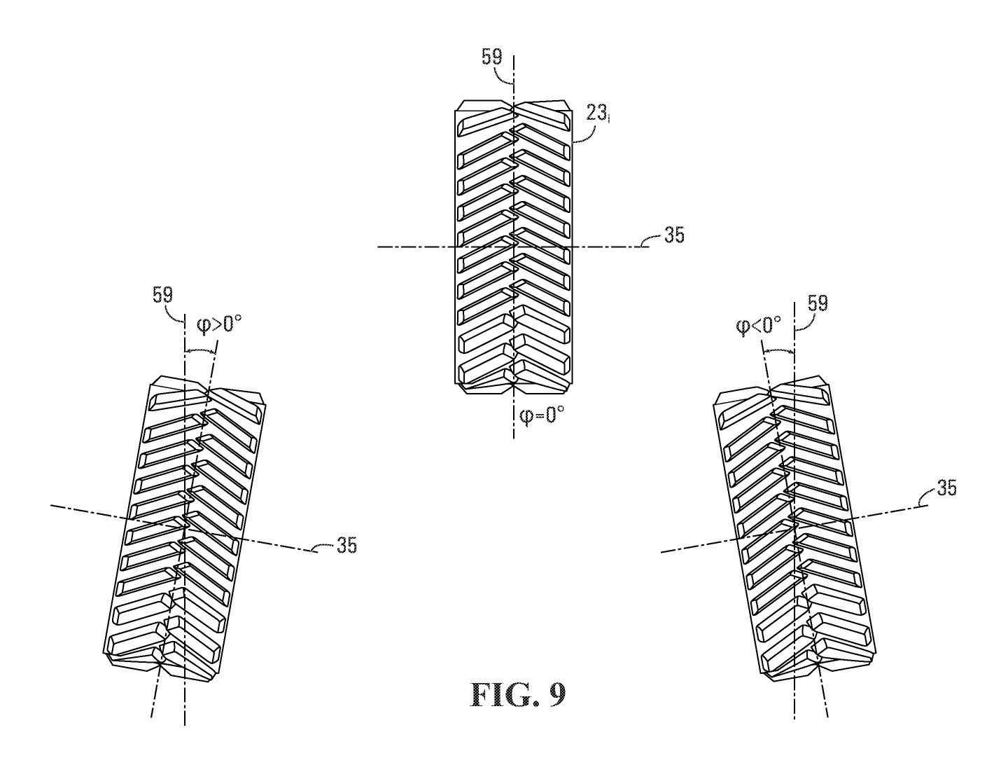

In this embodiment, the track assembly 16ᵢ comprises an alignment system 80 for adjusting alignment angles of the front idler wheels 23₁, 23₂. More specifically, as shown in FIG. 9, in this embodiment, the alignment system 80 enables adjustment of an alignment angle φ made by each of the front idler wheels 23₁, 23₂ with the longitudinal axis 59 of the track assembly 16ᵢ. This allows each of the front idler wheels 23₁, 23₂ to be placed in a “toe-in” or “toe-out” position. In some cases, this may help to reduce wear of certain parts of the track 22 (e.g., the guide lugs 34₁-34_{N}).

More particularly, in this embodiment, the alignment system 80 comprises an alignment member 81 connected between the frame 17 and the link 71 mounted to the axle 51 of the front idler wheels 23₁, 23₂. The alignment member 81 is pivotally connected to the frame 17 via a pivot 83 which allows the alignment member 81 to pivot about a generally vertical axis extending through the pivot 83. A manual adjustment unit 84 enables an orientation of the alignment member 81 about the pivot 83 to be manually adjusted. In this case, the manual adjustment unit 84 comprises a pair of threaded rods 85₁, 85₂ connected between the alignment member 81 and the frame 17 such that, as they are manually turned, they cause pivoting of the alignment member 81 about the pivot 83 in a desired direction. The alignment member 81 thus moves the link 71 in a corresponding direction, thereby adjusting the angle φ made by each of the front idler wheels 23₁, 23₂ with the longitudinal axis 59 of the track apparatus 16ᵢ. The tensioning system 68 may accommodate this motion of the link 71 in various ways. For example, the piston-cylinder arrangement 69 may have some play at its connection to the frame 17 and/or to the link 71 to permit this motion of the link 71.

The alignment system 80 may be constructed in various other manners and/or using various other materials in other embodiments. Also, in other embodiments, the alignment system 80 may be configured to allow adjustment of alignment angles of other wheels of the track apparatus 16ᵢ, such as the rear idler wheels 26₁, 26₂, in addition to or instead of the front idler wheels 23₁, 23₂. Furthermore, in other embodiments, the alignment system 80 may enable adjustment of other alignment angles (e.g., camber angle, castor angle) made by wheels of the track apparatus 16ᵢ in addition to or instead of the angle φ.

The track assemblies 16₁, 16₂ thus enable the agricultural vehicle 10 to be propelled efficiently on the ground. In particular, they enhance traction and floatation of the agricultural vehicle 10 on the ground while allowing it to travel at relatively high speed.

While in this embodiment the track assemblies 16₁, 16₂ are configured in a certain way, the track assemblies 16₁, 16₂ may be configured in various other ways in other embodiments.

For example, in some embodiments, instead of engaging the inner side 25 of the endless track 22 in a first region between the inboard lateral edge 57 of the track 22 and each of the wheels 23₁, 23₂, 26₁, 26₂, 28₁-28₄, 21₁, 21₂ and in a second region between the outboard lateral edge 56 of the track 22 and each of the wheels 23₁, 23₂, 26₁, 26₂, 28₁-28₄, 21₁, 21₂, the driver wheel 24 may engage the inner side 25 of the track 22 in only one of these regions (e.g., the driver wheel 24 may comprise only one of the driver wheel members 29₁, 29₂ with the other one being omitted) or in another region (e.g., the driver wheel 24 may comprise a single driver wheel member the driver wheel members 29₁, 29₂ that is located laterally between the wheels 23₁, 23₂, 26₁, 26₂, 28₁-28₄, 21₁, 21₂).

As another example, in some embodiments, the driver wheel 24 may drive the endless track 22 in another manner in addition to or instead of by friction. For instance, in some cases, the driver wheel 24 may comprise a drive sprocket including teeth or bars and the inner side 25 of the endless track 22 may comprise drive projections (sometimes referred to as “drive lugs”), which interact with the teeth or bars of the drive sprocket in order to cause the endless track 22 to be driven. In other words, the driver wheel 24 and the track 22 may implement a “positive drive” system. The drive lugs may be provided in addition to or instead of the guide lugs 34₁-34_{N} and may also serve to guide the endless track 22 as it is driven around the wheels 23₁, 23₂, 26₁, 26₂, 28₁-28₄, 21₁, 21₂. In other cases, the driver wheel 24 may drive the endless track 22 in yet other manners.

As yet another example, in other embodiments, the track assembly 16ᵢ may comprise more or less bogie wheels such as the bogie wheels 28₁-28₄. For example, in some cases, the track apparatus 16ᵢ may comprise additional bogie wheels, possibly arranged in one or more additional tandems such as those formed by the bogie wheels 28₁, 28₂ and by the bogie wheels 28₃, 28₄. In other cases, the track assembly 16ᵢ may not comprise any tandem at all. Similarly, in some cases, the track assembly 16ᵢ may comprise more or less upper roller wheels such as the upper roller wheels 21₁, 21₂.

As yet another example, in other embodiments, the tensioning system 68, the suspension 74, and/or the alignment system 80 may be configured in other ways or omitted in some cases. For example, in some embodiments, the end portion 70₂ of the piston-cylinder arrangement 69 may be connected to the link 71 at a location below the axis of rotation 35 of the front idler wheels 23₁, 23₂ and/or the end portion 70₁ of the piston-cylinder arrangement 69 may be connected to the lower portion 76₁ of the frame 17 (e.g., both the end portion 70₁ and the end portion 70₂ of the piston-cylinder arrangement 69 may be connected at respective locations below the axis of rotation 35 of the front idler wheels 23₁, 23₂ such that the piston-cylinder arrangement 69 is substantially horizontal).

As yet another example, the endless track 22 may be constructed in various other ways and/or using various other materials in other embodiments. Also, while in this embodiment the endless track 22 is a one-piece jointless track, in other embodiments, the endless track 22 may be a “segmented” track comprising a plurality of track sections interconnected to one another at a plurality of joints. In other embodiments, the endless track 22 may be a one-piece track that can be closed like a belt with connectors at both of its longitudinal ends to form a joint.

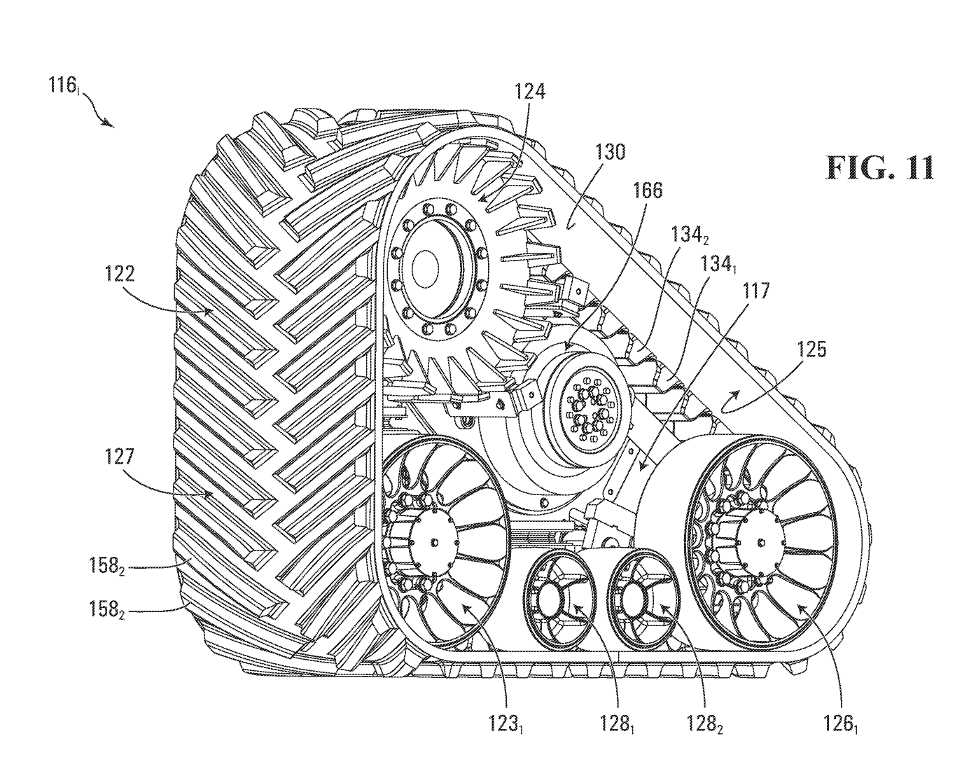

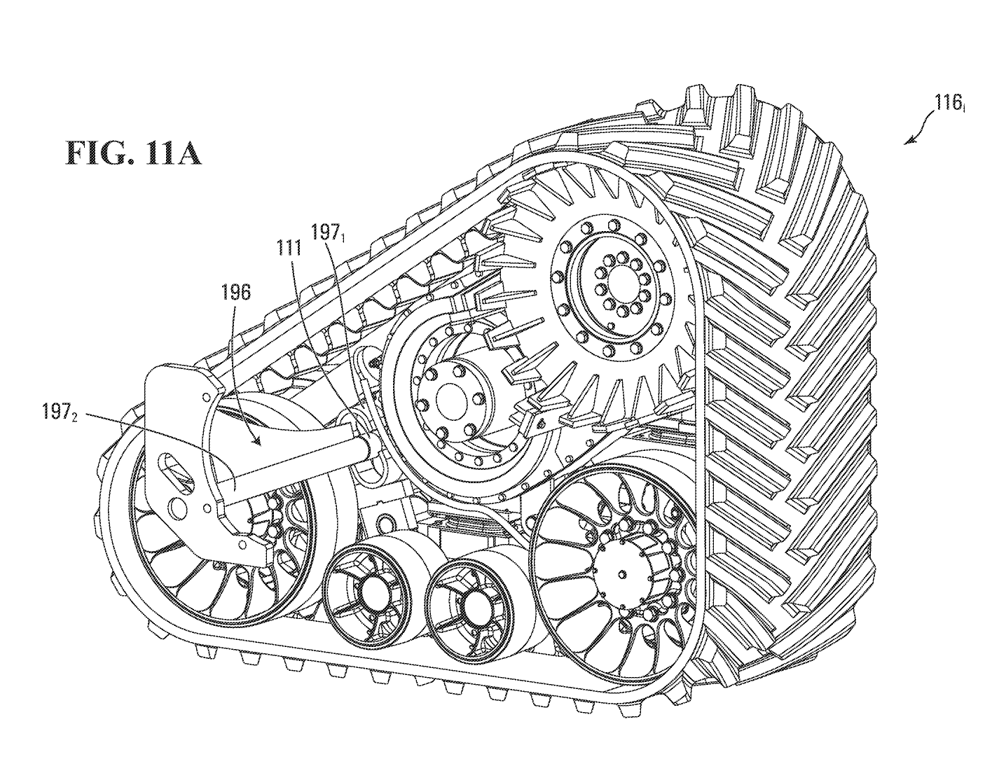

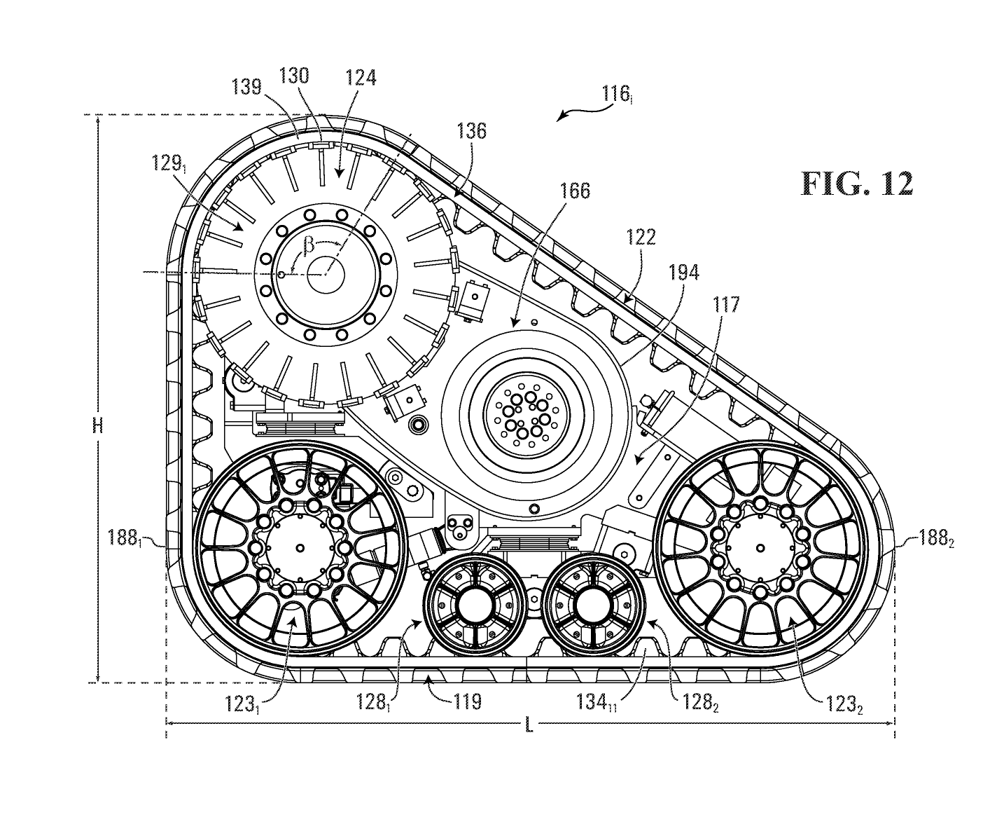

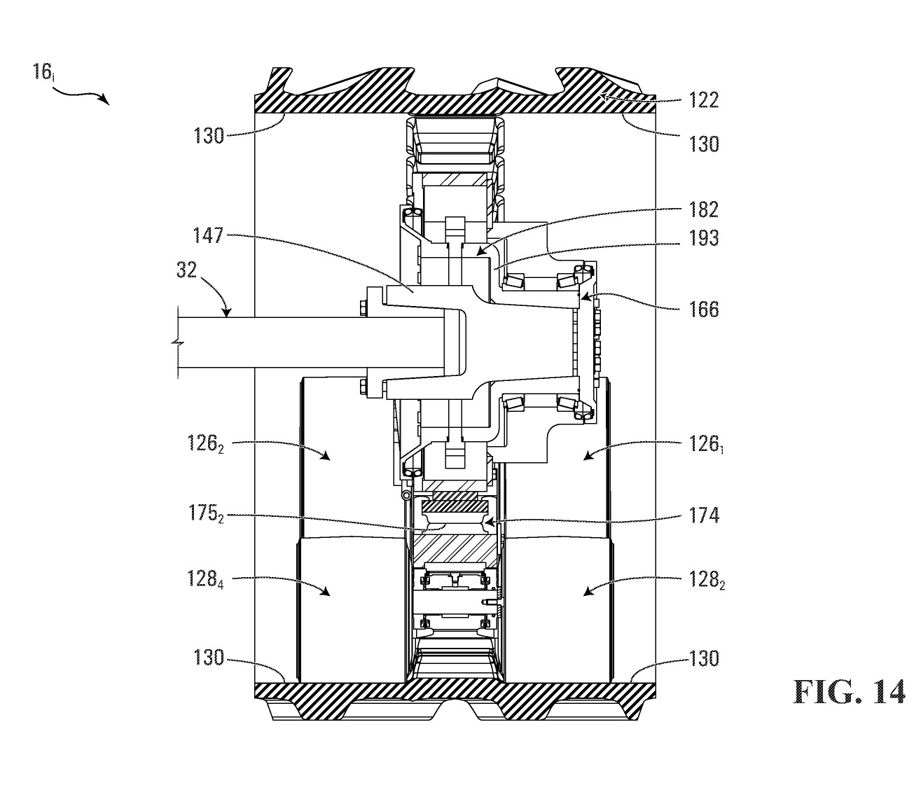

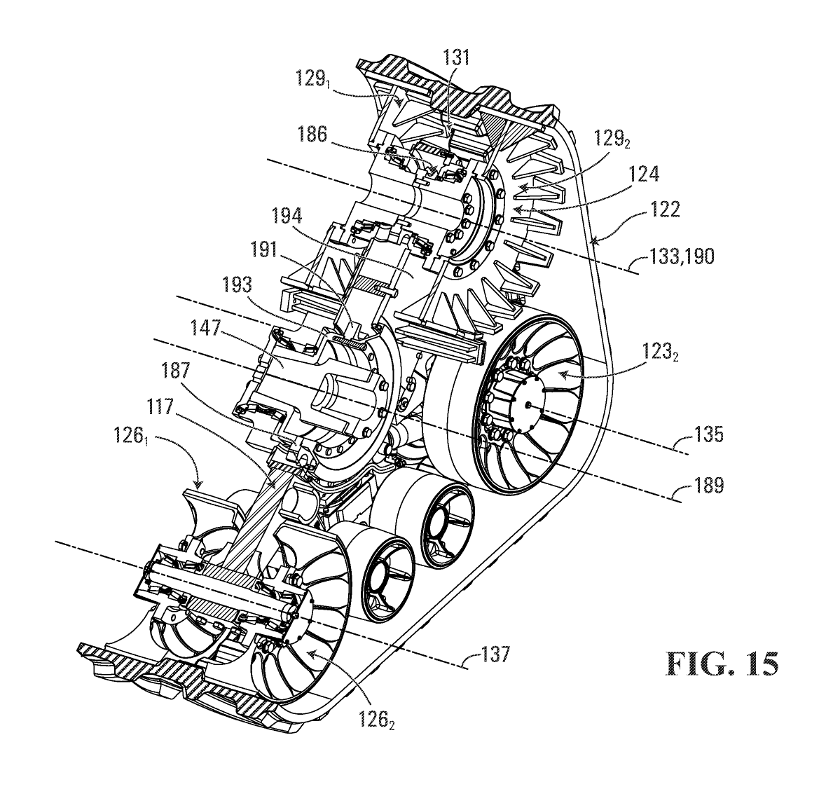

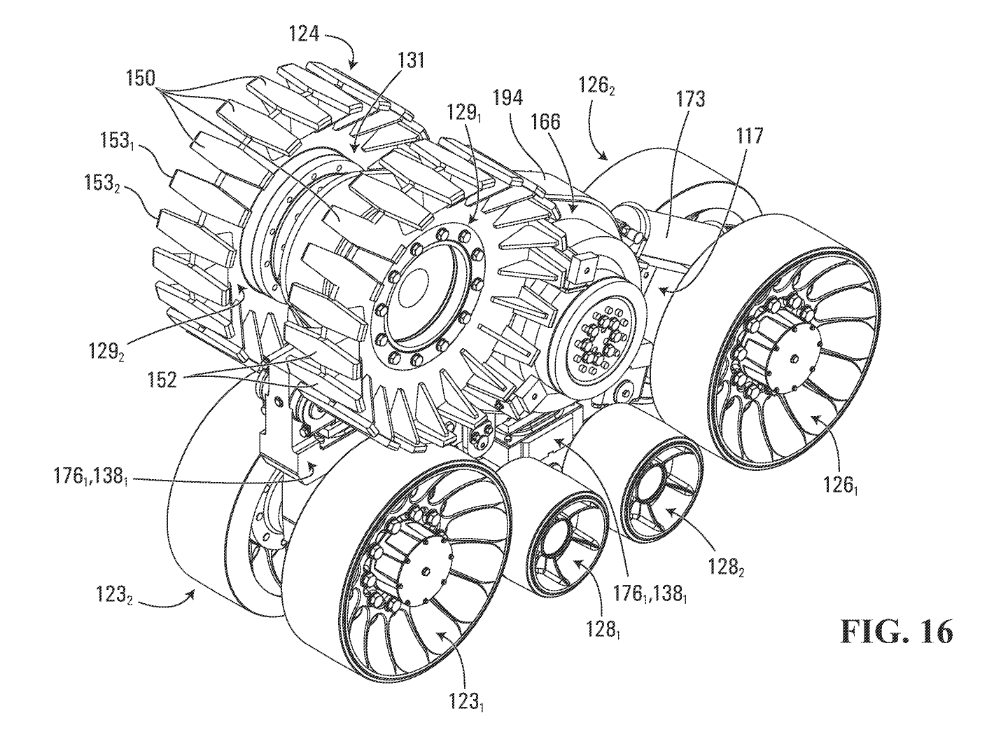

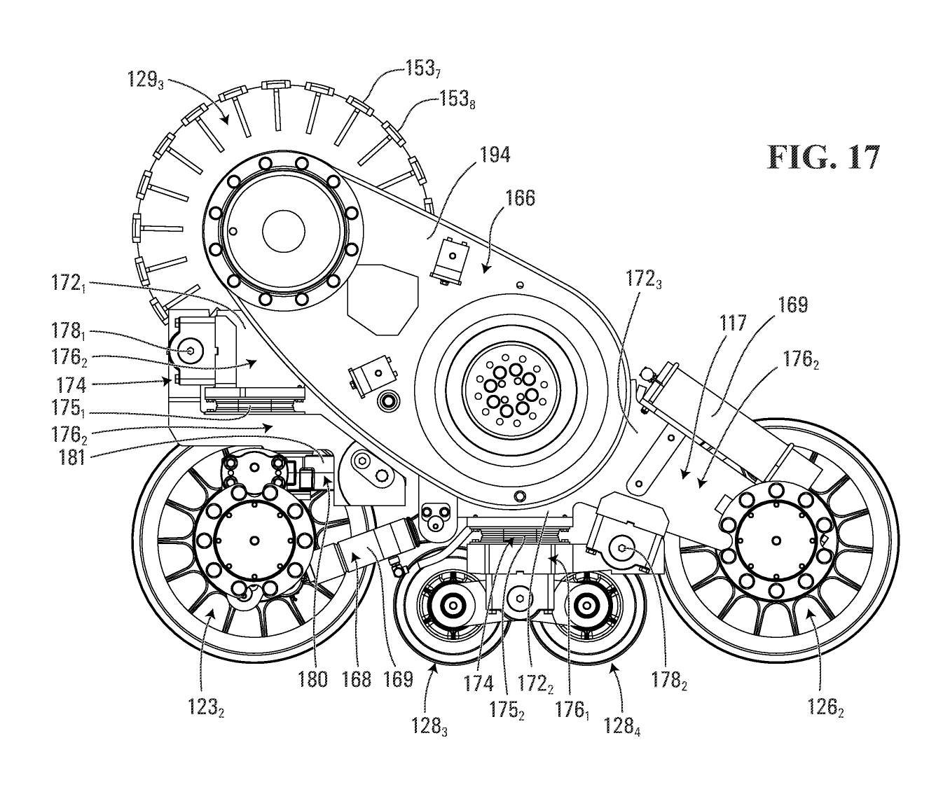

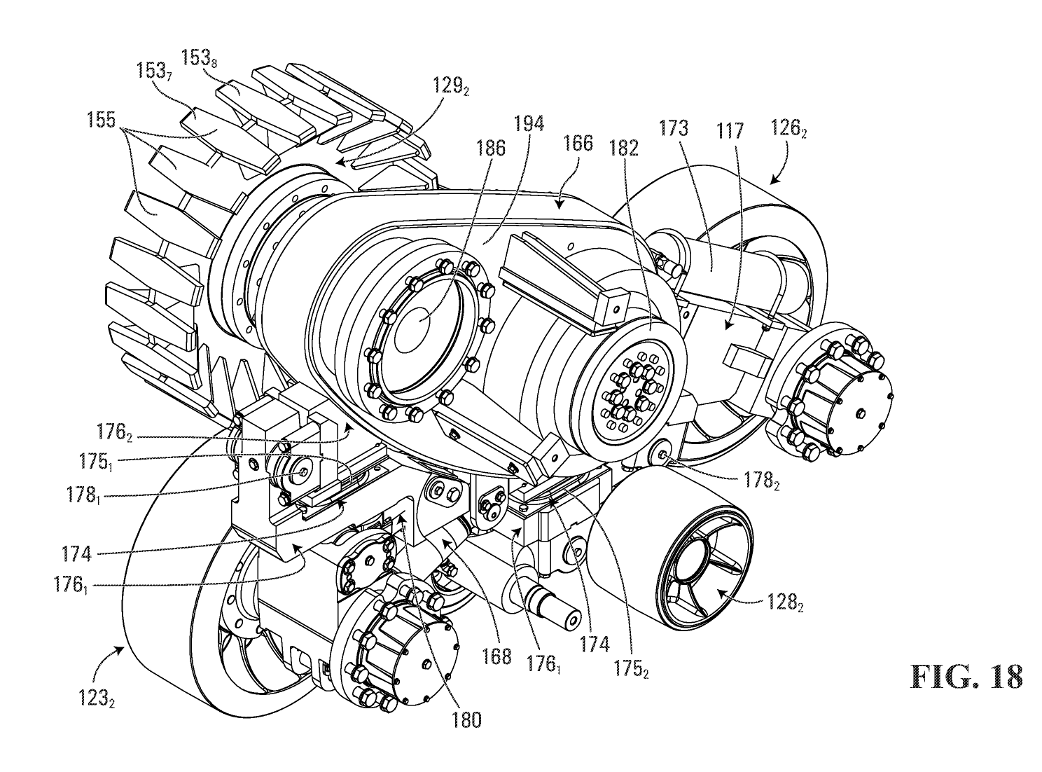

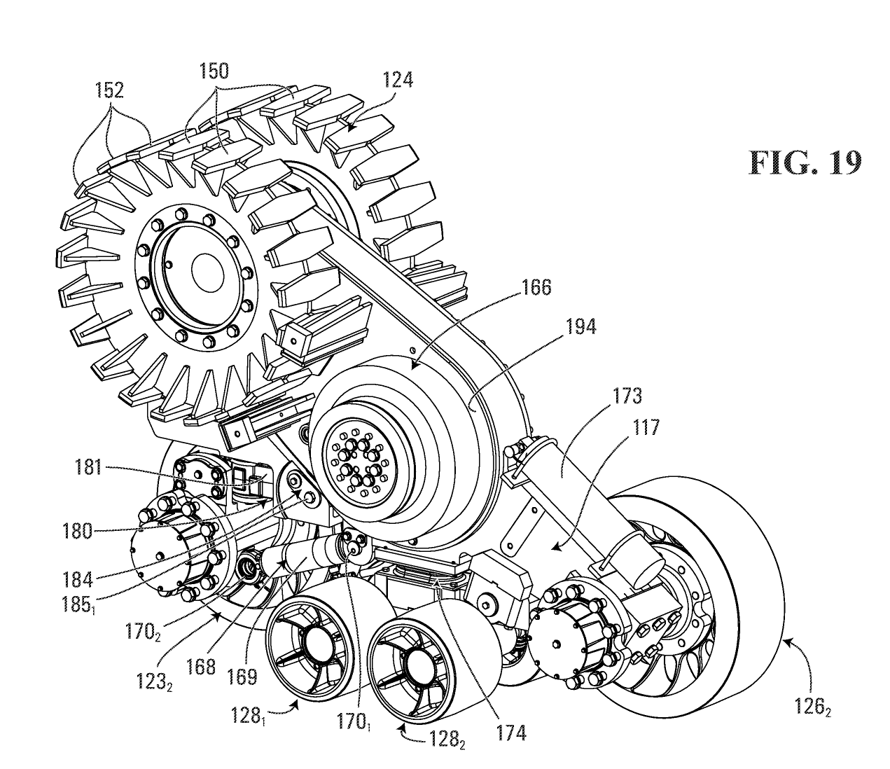

FIGS. 11 to 19 show a track assembly 116, in accordance with another embodiment of the invention. In this embodiment, the track assembly 116, is one of a set of track assemblies 116₁, 116₂ which can be provided on the agricultural vehicle 10 as described above in respect of the track assemblies 16₁, 16₂.

In this embodiment, the track assembly 116, comprises a frame 117; a plurality of wheels, including a driver wheel 124 and a plurality of idler wheels, which includes front idler wheels 123₁, 123₂, rear idler wheels 126₁, 126₂, and lower roller wheels 128₁-128₄; and an endless track 122 disposed around these wheels. These components of the track assembly 116ᵢ have respective functions which mirror those of the frame 17, the driver wheel 24, the idler wheels 23₁, 23₂, 26₁, 26₂, 28₁-28₄, and the endless track 22 of the track assembly 16ᵢ as discussed above. Other components of the track assembly 116ᵢ whose functions mirror those of equivalent components of the track assembly 16ᵢ are designated by reference numerals that correspond to reference numerals designating these equivalent components of the track assembly 16ᵢ plus one hundred.

Also, in this embodiment, the track assembly 116ᵢ comprises a transmission 166 between the axle 32 of the agricultural vehicle 10 and the driver wheel 124.

The track assembly 116ᵢ is mounted to the axle 32 of the agricultural vehicle 10. More particularly, in this embodiment, the transmission 166 is mounted to the axle 32 of the agricultural vehicle 10.

The transmission 166 transmits power from the axle 32 to the driver wheel 124 and performs a speed conversion such that the driver wheel 124 rotates at a rotational speed different from a rotational speed of the axle 32.

The transmission 166 comprises a first portion 182 connected to the axle 32 of the agricultural vehicle 10 and a second portion 186 connected to the driver wheel 24. The first portion 182 of the transmission 166 has an axis 189 defined by the axle 32, while the second portion 186 of the transmission 166 has an axis 190 generally coaxial with an axis of rotation 133 of the driver wheel 124. In this case, the axis 190 of the second portion 186 of the transmission 166 is spaced apart from the axis 189 of the first portion 182 of the transmission 166 in the longitudinal direction of the track assembly 116ᵢ and in the height direction of the track assembly 116ᵢ. Thus, in this case, the axis of rotation 133 of the driver wheel 124 is spaced apart from the axis of rotation of the axle 32 in the longitudinal direction of the track assembly 116ᵢ and in the height direction of the track assembly 116ᵢ. In other cases, the axis of rotation 133 of the driver wheel 124 may be aligned with the axis of rotation of the axle 32 in the longitudinal direction of the track assembly 116, and/or in the height direction of the track assembly 116ᵢ.

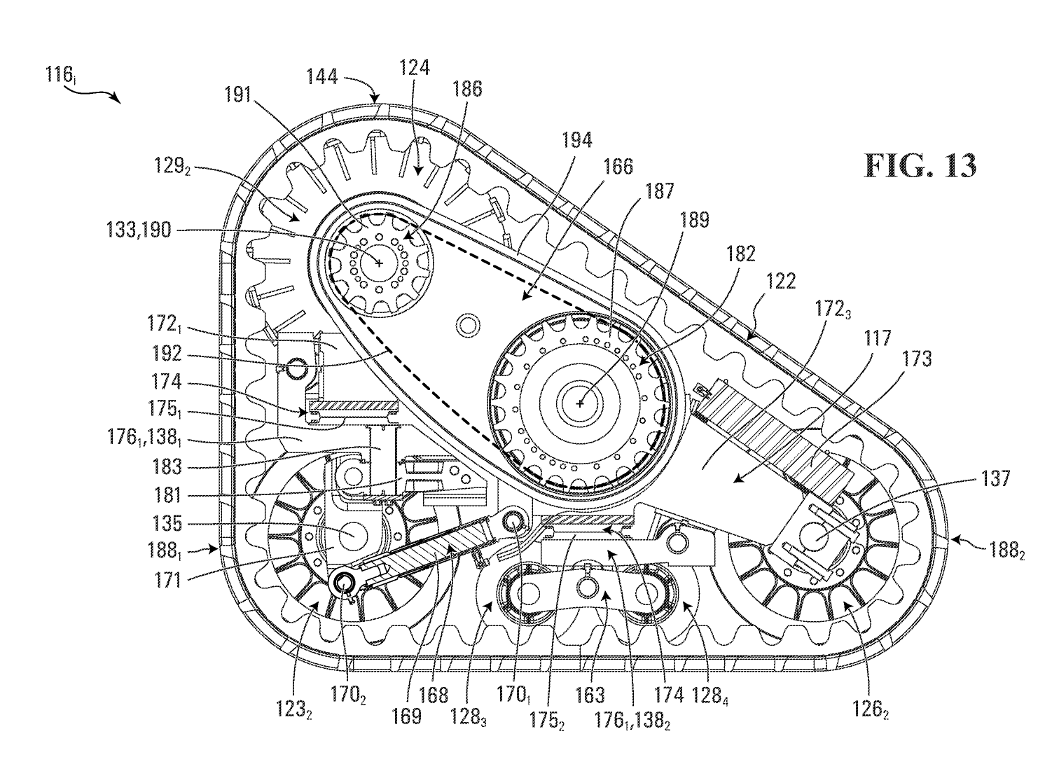

In this embodiment, the first portion 182 of the transmission 166 comprises a first transmission wheel 187 and the second portion 186 of the transmission 166 comprises a second transmission wheel 191. The transmission wheels 187, 191 are interconnected by an endless transmission member 192 disposed around the transmission wheels 187, 191. The endless transmission member 192 is shown in dotted line in FIG. 13. More particularly, in this embodiment, each of the transmission wheels 187, 191 is a sprocket gear and the endless transmission member 192 is a transmission chain. The transmission wheels 187, 191 and the endless transmission member 192 may take on other forms in other embodiments (e.g., each of the transmission wheels 187, 191 may be a pulley and the endless transmission member 192 may be a transmission belt).

In this case, the sprocket gear 187 is larger than the sprocket gear 191 such that the sprocket gear 191 rotates faster than the sprocket gear 187. In turn, this causes the driver wheel 124 to rotate faster than the axle 32 of the agricultural vehicle 10. A transmission ratio T can be selected so as to provide a desired speed conversion. The transmission ratio T can be expressed as a ratio ωₒ/ωᵢ of an output rotational speed ωₒ of the transmission 166, which in this case is the rotational speed of the driver wheel 124, to an input rotational speed ωᵢ of the transmission 166, which in this case is the rotational speed of the axle 32 of the agricultural vehicle 10. For example, in some embodiments, the transmission ratio T of the transmission 166 may be at least 1.25, in some cases at least 1.50, in some cases at least 1.75, in some cases at least 2, in some cases at least 2.25, and in some cases even more (e.g., at least 2.75). The transmission ratio T can take on various other values in other embodiments.

In embodiments in which the track assemblies 16₁, 16₂ are used in place of ground-engaging wheels 15₁, 15₂ on which the agricultural vehicle 10 can be propelled on the ground, the transmission ratio T may be selected such that the speed of the agricultural vehicle 10 when equipped with the track assemblies 16₁, 16₂ corresponds or is as close as possible to the speed of the agricultural vehicle 10 when equipped with the ground-engaging wheels 15₁, 15₂. For instance, in some cases, the transmission ratio T may be selected on a basis of the diameter D of the driver wheel 124 and the diameter D_{w} of a ground-engaging wheel 15ᵢ specified for the agricultural vehicle 10.

While in this embodiment the sprocket gear 191 rotates faster than the sprocket gear 187, in other embodiments, the sprocket gear 187 may be smaller than the sprocket gear 191 such that the sprocket gear 191 rotates slower than the sprocket gear 187. In other words, in some embodiments, the transmission ratio T of the transmission 166 may be less than 1 (e.g., between 0.8 and 1).

As indicated above, in this embodiment, the transmission 166 is mounted to the axle 32 of the agricultural vehicle 10. In this example, a hub 193 of the sprocket gear 187 is mounted to the axle 32 via a bushing 147. In this case, the bushing 147 is a tapered bushing.

The transmission 166 comprises a housing 194 in which are housed the sprocket gears 187, 191 and the transmission chain 192. In addition to its housing function, in this embodiment, the housing 194 of the transmission 166 also has a support function. Indeed, in this embodiment, the housing 194 of the transmission 166 supports the driver wheel 124 in position and supports the frame 117, which supports the idler wheels 123₁, 123₂, 1261, 126₂, 128₁-128₄.

More particularly, in this embodiment, the housing 194 of the transmission 166 is joined to front, central and rear parts 172₁, 172₂, 172₃ of the frame 117 which are respectively located in front, beneath and behind the transmission 166. For example, in some embodiments, the parts 172₁, 172₂, 172₃ of the frame 117 may be fastened or welded to the housing 194 of the transmission 166. In other embodiments, the parts 172₁, 172₂, 172₃ of the frame 117 may be integrally formed with the housing 194 of the transmission 166 (e.g., the parts 172₁, 172₂, 172₃ of the frame and the housing 194 of the transmission 166 may be cast together).

The driver wheel 124 is rotatable by power derived from the prime mover 14 to impart motion to the endless track 22. The driver wheel 124 thus rotates when the axle 32 of the agricultural vehicle 10 rotates. More particularly, in this embodiment, the driver wheel 124 is coupled to the transmission 166 such that, when the axle 32 of the agricultural vehicle 10 rotates, the transmission 166 transmits power to rotate the driver wheel 124. Thus, in this case, the axis of rotation of the axle 32 does not correspond to the axis of rotation 133 of the driver wheel 124. The driver wheel 124 contacts the upper run 136 of the endless track 122 and is vertically spaced apart from the lower run 119 of the endless track 122.

In this embodiment, the driver wheel 124 comprises a friction drive surface 150 that frictionally engages a friction drive surface 130 of the endless track 122 such that, as the driver wheel 124 rotates, friction between the friction drive surface 130 of the endless track 122 and the friction drive surface 150 of the driver wheel 124 causes motion of the endless track 122 around the wheels 124, 23₁, 23₂, 26₁, 26₂, 28₁-28₄, to propel the agricultural vehicle 10 on the ground.

More particularly, in this embodiment, the drive wheel 124 comprises a first driver wheel portion 129₁ and a second driver wheel portion 129₂ that are spaced apart along the axis of rotation 133 of the driver wheel 124 to define a space 131 therebetween. In this case, the driver wheel portions 129₁, 129₂ are two (2) driver wheel members that are separate from one another. In other cases, the driver wheel portions 129₁, 129₂ may be integral with one another.

Each driver wheel member 129ᵢ has a periphery contacting the inner side 125 of the endless track 122 to impart motion to the endless track 122. In this embodiment, the periphery of the driver wheel member 129ᵢ comprises a friction drive surface 152 that frictionally engages the friction drive surface 130 of the endless track 122 in order to frictionally drive the endless track 122. Thus, in this case, the friction drive surface 152 of the driver wheel member 129₁ and the friction drive surface 152 of the driver wheel member 129₂ constitute the friction drive surface 150 of the driver wheel 124.

In this embodiment, the periphery of the driver wheel member 129ᵢ comprises a plurality of driving protrusions (e.g., driving fingers) 153₁-153_{N} spaced apart circumferentially from one another. Adjacent ones of the driving protrusions 153₁-153_{N} can be viewed as defining openings (e.g., slots) in the periphery of the driver wheel member 129ᵢ. In this example, the driving protrusions 153₁-153_{N} are shaped as plates. The driving protrusions 153₁-153_{N} may have various other shapes in other examples.

Each of the driving protrusions 153₁-153_{N} has a friction drive surface 155 that frictionally engages the friction drive surface 130 of the endless track 122 in order to frictionally drive the endless track 122. Thus, in this case, the friction drive surface 152 of the driver wheel member 129ᵢ is constituted by the friction drive surface 155 of each of the driving protrusions 153₁-153_{N}.

The driver wheel 124 contacts the endless track 122 along an arc of contact that subtends the angle of wrap β, which can take on various values. For example, in some embodiments; the angle of wrap β may be of at least 100°, in some cases at least 110°, and in some cases at least 120°. In this embodiment, the angle of wrap β is about 130°.

In this embodiment, the transmission 166 is located between the first driver wheel member 129₁ and the second driver wheel member 129₂ of the driver wheel 124 in the transversal direction of the track assembly 116ᵢ. This may allow frictional forces between the driver wheel 124 and the endless track 122 to be more evenly distributed across the width of the endless track 122, thereby enhancing the frictional driving efficiency.

As best viewed in FIG. 13, in this embodiment, the axis of rotation of the axle 32 of the agricultural vehicle 10 is located between respective axes of rotation 135, 137 of the front idler wheels 123₁, 123₂ and the rear idler wheels 126₁, 126₂. Also, the axis of rotation 133 of the driver wheel 124 is located between the axes of rotation 135, 137 of the front idler wheels 123₁, 123₂ and the rear idler wheels 126₁, 126₂. However, in this embodiment, as mentioned above, the axis of rotation 133 of the driver wheel 124 is spaced apart from the axis of rotation of the axle 32 of the agricultural vehicle 10 in the longitudinal direction of the track assembly 116ᵢ and in the height direction of the track assembly 116ᵢ. Basically, in this case, the driver wheel 124 is offset from the axle 32 of the agricultural vehicle 10 towards a front longitudinal end 188₁ and a top 144 of the track assembly 116ᵢ. This offset may help to optimize the angle of wrap β of the endless track 122 about the driver wheel 124, thus enhancing traction. In this example, this offset is such that the track assembly 116ᵢ has a generally right-triangular configuration in which a front segment of the endless track 122 is generally vertical.

The track assembly 116ᵢ may be dimensioned such that the vertical distance V between the axis of rotation of the axle 32 of the agricultural vehicle 10 and the ground when the track assembly 116ᵢ is mounted to the axle 32 substantially corresponds to the vertical distance V_{w} between the axis of rotation of the axle 32 of the agricultural vehicle 10 and the ground when a ground-engaging wheel 15ᵢ, which could be used in place of the track assembly 116ᵢ, is mounted to the axle 32. Basically, the track assembly 116ᵢ may be dimensioned such that, when the track assembly 116ᵢ is mounted to the axle 32, the axle 32 lies at a level above the ground which is substantially maintained to that at which the axle 32 lies when the ground-engaging wheel 15ᵢ is mounted to the axle 32. This allows the agricultural vehicle 10 to substantially remain at the same height relative to the ground as if it was on the ground-engaging wheel 15ᵢ, which may allow more stable motion of the agricultural vehicle 10, especially at higher speed.

For example, in some embodiments, the ratio V/V_{w} of the vertical distance V between the axis of rotation of the axle 32 of the agricultural vehicle 10 and the ground when the track assembly 116ᵢ is mounted to the axle 32 and the vertical distance V_{w} between the axis of rotation of the axle 32 of the agricultural vehicle 10 and the ground when the ground-engaging wheel 15ᵢ is mounted to the axle 32 may be between 0.9 and 1.1, in some cases between 0.925 and 1.075, in some cases between 0.95 and 1.05, and in some cases between 0.975 and 1.025.

The driver wheel 124 can thus efficiently drive the endless track 122. In particular, the driver wheel 124 allows the endless track 122 to be driven at relatively high speed. In turn, this enables the agricultural vehicle 10 to travel on the ground at relatively high speed.

For example, in embodiments in which the track assemblies 116₁, 116₂ are used in place of ground-engaging wheels 15₁, 15₂ on which the agricultural vehicle 10 can be propelled on the ground, the track assemblies 116₁, 116₂ may enable the agricultural vehicle 10 to travel on the ground at an operational speed of up to at least 80%, in some cases up to at least 85%, and in some cases up to at least 90%, and in some cases up to at least 95% of the maximum operational speed S_{w} of the agricultural vehicle 10 when propelled on the ground by the ground-engaging wheels 15₁, 15₂. Thus, the ratio S/S_{w} of the maximum operational speed S of the agricultural vehicle 10 when propelled on the ground by the track assemblies 116₁, 116₂ to the maximum operational speed S_{w} of the agricultural vehicle 10 when propelled on the ground by the ground-engaging wheels 15₁, 15₂ may be at least 0.8, in some cases at least 0.85, in some cases at least 0.9, and in some cases at least 0.95. In some examples, the operational speed of the agricultural vehicle 10 when equipped with the track assemblies 16₁, 16₂ may reach 100% of the maximum operational speed of the agricultural vehicle 10 when equipped with the ground-engaging wheels 15₁, 15₂. This is facilitated in this embodiment owing to the presence of the transmission 166.

As discussed previously, the ratio S/S_{w} of the maximum operational speed S of the agricultural vehicle 10 when propelled on the ground by the track assemblies 116₁, 116₂ to the maximum operational speed S_{W} of the agricultural vehicle 10 when propelled on the ground by the ground-engaging wheels 15₁, 15₂ may be evaluated based on geometrical considerations. For example, in this embodiment, the ratio S/S_{w} may be evaluated by multiplying the ratio D/D_{w} of the diameter D of the driver wheel 124 to the diameter D_{w} of the ground-engaging wheel 15ᵢ by the transmission ratio T of the transmission 166 (i.e., T×D/D_{w}).

In this embodiment, by being mounted to the agricultural vehicle 10 at the axle 32, the track assembly 116ᵢ is pivotable relative to a remainder of the agricultural vehicle 10 about a pivot axis which generally corresponds to the axis of rotation of the axle 32. In this case, a bearing 198 is associated a pivot movement of the track assembly 116ᵢ about the axis of rotation of the axle 32.

As shown in FIG. 11A, in this embodiment, an anti-rotation connector 196 is connected between the frame 117 of the track assembly 116ᵢ and the frame 12 of the agricultural vehicle 10 in order to limit the pivot movement of the track assembly 116ᵢ. The anti-rotation connector 196 comprises a first portion 197₁ which is connected to the frame 117 of the track assembly 16ᵢ and a second portion 197₂ which is connected to the frame 12 of the agricultural vehicle 10. In this example, these portions of the anti-rotation connector 196 are linked to one another such that the first portion 197₁ of the anti-rotation connector 196 is movable relative to the second portion 197₂ of the anti-rotation connector 196, which is fixed to the frame 12 of the vehicle 10. In this case, the first portion 197₁ of the anti-rotation connector 96 comprises a pair of C-shaped stops opposite one another and the second portion 197₂ of the anti-rotation connector 196 comprises a bar leading to a plate that is fixed (e.g., fastened) to the frame 12 of the vehicle 10. Here, an end part of the bar of the second portion 197₂ of the anti-rotation connector 196 comprises an elastic element 111. When either of the C-shaped stops of the first portion 197₁ of the anti-rotation connector 196 moves towards and contacts the elastic element 111 of the end part of the second portion 197₂ of the anti-rotation connector 96 due to the pivot movement of the track assembly 116ᵢ, the elastic element 111 acts as a damper or shock absorber and prevents further pivoting of the track assembly 116ᵢ, thereby limiting the pivot movement of the track assembly 16ᵢ. In this example, the elastic element 111 is an elastomeric member (e.g., a rubber spring). In other examples, the elastic element 111 may be take on other forms, or may be omitted from the anti-rotation connector 196.

In this embodiment, the track assembly 116ᵢ comprises a suspension 174 for improving ride quality on the ground and/or absorbing shocks experienced by the track assembly 116ᵢ. More particularly, in this embodiment, the suspension 174 comprises a first elastic element 175₁ and a second elastic element 175₂ that are elastically deformable to allow movement of a first portion 176₁ of the frame 117 relative to a second portion 176₂ of the frame 117. In this example, each of the elastic elements 175₁, 175₂ is an elastomeric member (e.g., a rubber bushing or a rubber spring such as a single or double convolution rubber spring). In other examples, each of the elastic elements 175₁, 175₂ may be a coil spring (e.g., a metallic or polymeric coil spring), a leaf spring, a gas spring (i.e., gas contained in a cylinder and variably compressed by a piston), or any other elastic object that deforms under stress and recovers its original configuration when the stress is released.

More particularly, in this embodiment, the first portion 176₁ of the frame 117 is a lower portion of the frame 117 that carries the idler wheels 123₁, 123₂, 126₁, 126₂, 128₁-128₄. In this case, the lower portion 176₁ of the frame 117 comprises a front lower part 138₁ of the frame 117 to which are mounted the front idler wheels 123₁, 123₂ and a central lower part 138₂ of the frame 117 to which are mounted the support wheels 128₁-128₄. Also, in this embodiment, the second portion 176₂ of the frame 117 is an upper portion of the frame 117 that is joined to the housing 194 of the transmission 166. Thus, in this case, the upper portion 176₂ of the frame 117 comprises the front, central and rear parts 172₁, 172₂, 172₃ of the frame 117. The lower and upper portions 176₁, 176₂ of the frame 117 are interconnected via the elastic elements 175₁, 175₂ and via pivots 178₁, 178₂ which allow them to pivot relative to one another. Thus, when the track assembly 116ᵢ moves on the ground, the lower portion 176₁ of the frame 117 may pivot relative to the upper portion 176₂ of the frame 117, thereby causing deformation (i.e., compression or extension) of either or both of the elastic elements 175₁, 175₂. Upon release of the stress to which it is subjected, each elastic element 175ᵢ may recover its original configuration, biasing the lower and upper portions 176₁, 176₂ of the frame 117 back to their respective original relative positions.

The suspension 174 may be constructed in various other ways and/or using various other materials in other embodiments. For example, in some embodiments, the suspension 174 may comprise a damper (i.e., a shock absorber), such as a hydraulic or pneumatic damper, a frictional damper (based on dry or fluid friction) or any other type of damper, to dampen shocks experienced by the track assembly 116ᵢ, to a greater extent than each elastic element 175ᵢ.

In this embodiment, the track assembly 116ᵢ comprises a tensioning system 168 for maintaining the endless track 122 in tension. In this example, the tensioning system 168 is an active tensioning system connected between the frame 117 and the front idler wheels 123₁, 123₂ to urge the front idler wheels 123₁, 123₂ in a direction to maintain the endless track 122 in tension.

More particularly, in this embodiment, the tensioning system 168 is a pressure-based tensioning system, i.e., a hydraulic or pneumatic tensioning system, which comprises a piston-cylinder arrangement 169 connected to a fluid reservoir 173 (e.g., a hydraulic piston-cylinder arrangement connected to a hydraulic accumulator). In this case, the fluid reservoir 173 is located on the rear part 176₁ of the frame 117 and connected to the piston-cylinder arrangement 169 via a fluid line which runs toward the front of the track assembly 116ᵢ. The piston-cylinder arrangement 169 has a first end portion 170₁ connected to the frame 117 and a second end portion 170₂ connected to a link 171 mounted to the axle of the front idler wheels 123₁, 123₂. In this example, the end portion 170₂ of the piston-cylinder arrangement 169 is connected to the link 171 at a location below the axis of rotation 135 of the front idler wheels 123₁, 123₂.

A piston of the piston-cylinder arrangement 169 is movable relative to a cylinder of the piston-cylinder arrangement 169 between an extended position and a retracted position. Pressure of a fluid inside the piston-cylinder arrangement 169 urges the piston towards its extended position. As a result, the piston pushes on the link 171 which biases the front idler wheels 123₁, 123₂ away from the rear idler wheels 126₁, 126₂, thereby maintaining the track 122 in tension. The tensioning system 168 allows tension in the track 22 to be manually adjusted to a desired level before use and remains active during use to maintain the tension in the track 122 at the desired level.

In this embodiment, the track assembly 116ᵢ comprises an alignment system 180 for adjusting alignment angles of the rear idler wheels 126₁, 126₂. More specifically, in this embodiment, the alignment system 180 enables adjustment of an alignment angle φ made by each of the rear idler wheels 126₁, 126₂ with the longitudinal axis 159 of the track assembly 116ᵢ, as shown in FIG. 9 with respect to the front idler wheels 123₁, 123₂ of the track assembly 16ᵢ.

More particularly, in this embodiment, the alignment system 180 comprises an alignment member 181 connected between the frame 117 and the link 171 mounted to the axle of the front idler wheels 123₁, 123₂. The alignment member 181 is pivotally connected to the frame 117 via a pivot 183 which allows the alignment member 181 to pivot about a generally vertical axis extending through the pivot 183. A manual adjustment unit 184 enables an orientation of the alignment member 181 about the pivot 183 to be manually adjusted. In this case, the manual adjustment unit 184 comprises a pair of threaded rods 185₁, 185₂ connected between the alignment member 181 and the frame 117 such that, as they are manually turned, they cause pivoting of the alignment member 181 about the pivot 183 in a desired direction. The alignment member 181 thus moves the link 171 in a corresponding direction, thereby adjusting the angle φ made by each of the front idler wheels 123₁, 123₂ with the longitudinal axis 159 of the track apparatus 116ᵢ.

The track assemblies 116₁, 116₂ may be configured in various other ways in other embodiments. For example, in some embodiments, possible variants discussed above in respect of the track assemblies 16₁, 16₂ may be applicable to the track assemblies 116₁, 116₂.

As another example, the transmission 166 may be implemented in various other ways in other embodiments. For instance, in other embodiments, the transmission 166 may comprise an arrangement of gears, a torque converter, and/or another transmission component, or may comprise another type of transmission (e.g., a continuously variable transmission (CVT), a hydrostatic or hydrodynamic transmission, an electric transmission, etc.). Also, while in this embodiment the transmission 166 implements a single transmission ratio T, in other embodiments, the transmission 166 may implement a set of two or more available transmission ratios from which a particular transmission ratio is selected and applied at any point in time (e.g., an automatic transmission).

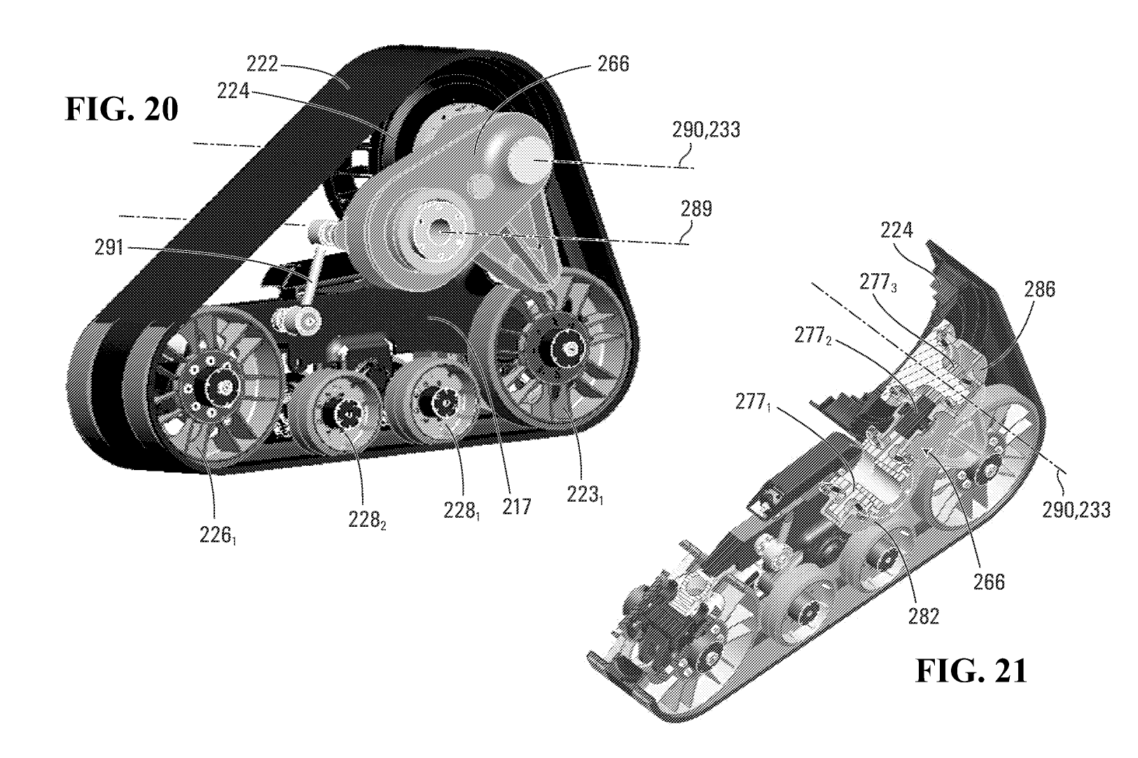

For instance, FIGS. 20 and 21 show a track assembly 216 in accordance with another embodiment of the invention. In this embodiment, the track assembly 216ᵢ is one of a set of track assemblies 216₁, 216₂ which can be provided on the agricultural vehicle 10 as described above in respect of the track assemblies 16₁, 16₂. The track assembly 216ᵢ is thus mounted to axle 32 of the agricultural vehicle 10.

In this embodiment, the track assembly 216ᵢ comprises a frame 217; a plurality of wheels, including a driver wheel 224 and a plurality of idler wheels, which includes front idler wheels 223₁, 223₂, rear idler wheels 226₁, 226₂, and lower roller wheels 228₁-228₄; and an endless track 222 disposed around these wheels. These components of the track assembly 216ᵢ have respective functions which mirror those of the frame 17, the driver wheel 24, the idler wheels 23₁, 23₂, 26₁, 26₂, 28₁-28₄, and the endless track 22 of the track assembly 16ᵢ as discussed above. Other components of the track assembly 216ᵢ whose functions mirror those of equivalent components of the track assembly 16ᵢ are designated by reference numerals that correspond to reference numerals designating these equivalent components of the track assembly 16ᵢ plus two hundred.

In addition, in this embodiment, the track assembly 216ᵢ comprises a transmission 266 between the axle 32 of the agricultural vehicle 10 and the driver wheel 224. The transmission 266 transmits power from the axle 32 to the driver wheel 224 and performs a speed conversion such that the driver wheel 224 rotates at a rotational speed different from the rotational speed of the axle 32.

More particularly, in this embodiment, the transmission 266 comprises a gearbox including a plurality of gears 277₁-277₃. The gear 277₁ is mounted to the axle 32, the gear 277₃ is mounted to the driver wheel 224, and the gear 277₂ is an idler gear. In this case, the gear 277₁ is larger than the gear 277₃ such that the gear 277₃ rotates faster than the gear 277₁. In turn, this causes the drive wheel 224 to rotate faster than the axle 32.

In this case, the transmission 266 is located on an outboard side of the track assembly 216ᵢ (i.e., a side of the track assembly 216ᵢ farthest from the centerline of the agricultural vehicle 10). In other cases, the transmission 266 may be located on an inboard side of the track assembly 216ᵢ (i.e., a side of the track assembly 216ᵢ closest to the centerline of the agricultural vehicle 10). This can allow the endless track 222 to be located closer to or further from the centerline of the agricultural vehicle 10.

In this embodiment, the driver wheel 224 and the endless track 222 implement a “positive drive” system. Specifically, the driver wheel 224 comprises a drive sprocket and the inner side 225 of the endless track 222 comprises drive lugs which interact with the drive sprocket such that rotation of the drive sprocket imparts motion of the endless track 222. In this case, the location of the transmission 266 on the outboard side of the track assembly 216ᵢ facilitates this positive drive system.

Although in embodiments considered above the track assemblies 16₁, 16₂ or 116₁, 116₂ or 216₁, 216₂ are provided in front of the agricultural vehicle 10 while the ground-engaging wheels 13₁, 13₂ are provided in its rear, in other embodiments, track assemblies such as the track assemblies 16₁, 16₂ or 116₁, 116₂ or 216₁, 216₂ may be provided in the rear or both in the front and the rear of the agricultural vehicle 10. In particular, in some embodiments, the agricultural vehicle 10 may be propelled only by track assemblies such as the track assemblies 16₁, 16₂ or 116₁, 116₂ or 216₁, 216₂ without any ground-engaging wheels.

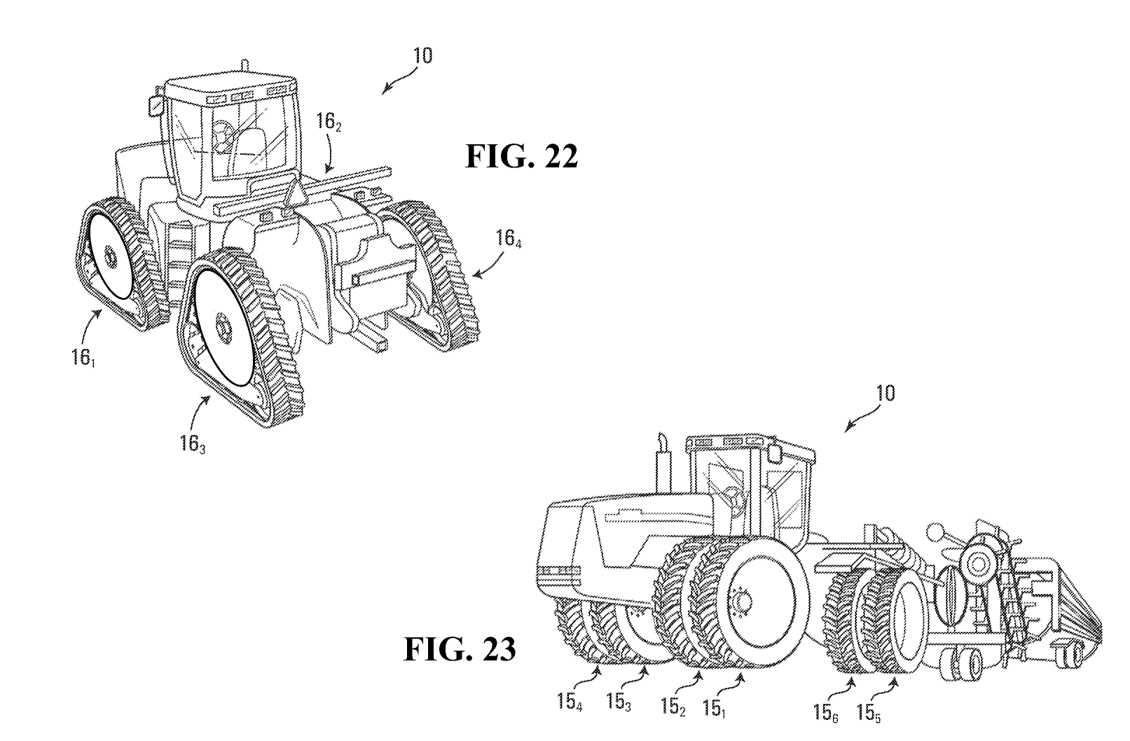

While in embodiments considered above the agricultural vehicle 10 is a combine harvester, the agricultural vehicle 10 may be another type of agricultural vehicle in other embodiments. For example, FIGS. 22 and 23 show an embodiment in which the agricultural vehicle 10 is a tractor. In this embodiment, the tractor 10 comprises a set of four track assemblies 16₁-16₄ like those discussed above. In this case, the track assemblies 16₁-16₄ are mounted in place of ground-engaging wheels 15₁-15₈ which could be mounted to the tractor 10 to propel it on the ground. In other embodiments, the tractor 10 may comprise a set of four track assemblies 116₁-116₄ or a set of four track assemblies 216₁-216₄ like those discussed above.

Although in embodiments considered above the work vehicle 10 is an agricultural vehicle for performing agricultural work, in other embodiments, the work vehicle 10 may be a construction vehicle (e.g., a loader, a bulldozer, an excavator, etc.) for performing construction work, a forestry vehicle (e.g., a feller-buncher, a tree chipper, a knuckleboom loader, etc.) for performing forestry work, a military vehicle (e.g., a combat engineering vehicle (CEV), etc.) for performing work in a military application, a transporter vehicle (e.g., a heavy hauler, a flatbed truck, a trailer, a carrier, etc.) for transporting equipment, materials, cargo or other objects, or any other vehicle operable off paved roads. Although operable off paved roads, a work vehicle may also be operable on paved roads in some cases. Also, while in embodiments considered above the work vehicle 10 is driven by a human operator in the vehicle 10, in other embodiments, the work vehicle 10 may be an unmanned ground vehicle (e.g., a teleoperated or autonomous unmanned ground vehicle).

While various embodiments and examples have been presented, this was for the purpose of describing, but not limiting, the invention. Various modifications and enhancements will become apparent to those of ordinary skill in the art and are within the scope of the invention, which is defined by the appended claims.

1. A track assembly for providing traction to a vehicle, the track assembly being mountable to an axle of the vehicle and comprising:
a) a plurality of wheels comprising:
i) a leading idler wheel and a trailing idler wheel spaced apart in a longitudinal direction of the track assembly, an axis of rotation of the axle of the vehicle being located between an axis of rotation of the leading idler wheel and an axis of rotation of the trailing idler wheel in the longitudinal direction of the track assembly; and
ii) a driver wheel for rotating when the axle of the vehicle rotates, the driver wheel comprising a friction drive surface;
and
b) an endless track disposed around the wheels, the endless track comprising an inner side facing the wheels and a ground-engaging outer side for engaging the ground, the inner side of the endless track comprising a friction drive surface for frictionally contacting the friction drive surface of the driver wheel such that, when the driver wheel rotates, friction between the friction drive surface of the driver wheel and the friction drive surface of the endless track causes motion of the endless track to propel the vehicle on the ground.

2. The track assembly claimed in claim 1, wherein the driver wheel comprises a first driver wheel portion and a second driver wheel portion that are spaced apart along an axis of rotation of the driver wheel to define a space therebetween.

3. The track assembly claimed in claim 2, wherein each of the leading idler wheel and the trailing idler wheel is located between the first driver wheel portion and the second driver wheel portion in a transversal direction of the track assembly.

4. The track assembly claimed in claim 2, wherein the first driver wheel portion is a first driver wheel member and the second driver wheel portion is a second driver wheel member separate from the first driver wheel member.

5. The track assembly claimed in claim 4, wherein each of the first driver wheel member and the second driver wheel member has a periphery comprising a plurality of protrusions spaced apart circumferentially from one another.

6. The track assembly claimed in claim 4; wherein each of the first driver wheel member and the second driver wheel member comprises a hub and a wheel body extending radially from the hub, the wheel body having a thickness in a direction generally parallel to the axis of rotation of the driver wheel that is substantially less than a dimension of the hub in the direction generally parallel to the axis of rotation of the driver wheel.

7. The track assembly claimed in claim 1, wherein the driver wheel has a periphery comprising a plurality of protrusions spaced apart circumferentially from one another, each of the protrusions having a friction drive surface which constitutes part of the friction drive surface of the driver wheel.

8. The track assembly claimed in claim 1, wherein the driver wheel has a diameter defining a circular area occupying a majority of an internal cross-sectional area of the track assembly perpendicular to an axis of rotation of the driver wheel and delimited by the inner side of the endless track.

9. The track assembly claimed in claim 8, wherein the circular area occupies more than half of the internal cross-sectional area of the track assembly.

10. The track assembly claimed in claim 1, wherein the track assembly has a height, the driver wheel occupying most of the height of the track assembly, the driver wheel contacting an upper run of the endless track and being vertically spaced apart from a lower run of the endless track.

11. The track assembly claimed in claim 10, wherein the track assembly has a length, the driver wheel occupying most of the length of the track assembly.

12. The track assembly claimed in claim 1, wherein the driver wheel has a diameter corresponding to at least 80% of a diameter of a ground-engaging specified for the vehicle which is mountable to the axle of the vehicle instead of the track assembly.

13. The track assembly claimed in claim 1, wherein the driver wheel overlaps part of each of the leading idler wheel and the trailing idler wheel.

14. The track assembly claimed in claim 1, wherein an angle of wrap of the endless track on the driver wheel is at least 100°.

15. The track assembly claimed in claim 1, wherein the .Ieading idler wheel is a first leading idler wheel and the trailing idler wheel is a first trailing idler wheel, the plurality of wheels comprising: a second leading idler wheel spaced apart from the first leading idler wheel in a transversal direction of the track assembly; and a second trailing idler wheel spaced apart from the first trailing idler wheel in the transversal direction of the track assembly.

16. The track assembly claimed in claim 1, wherein the plurality of wheels comprises a plurality of support wheels located between the leading idler wheel and the trailing idler wheel in the longitudinal direction of the track assembly.

17. The track assembly claimed in claim 16, comprising a wheel-carrying structure pivotally mounted to a frame of the track assembly via a pivot and carrying first and second ones of the support wheels.

18. The track assembly claimed in claim 1, wherein the plurality of wheels comprises an upper roller wheel contacting an upper run of the endless track.

19. The track assembly claimed in claim 1, wherein the inner side of the endless track comprises a plurality of guide projections spaced apart in the longitudinal direction of the endless track for guiding the endless track.

20. The track assembly claimed in claim 1, wherein the driver wheel is mounted to the axle of the vehicle such that an axis of rotation of the driver wheel corresponds to the axis of rotation of the axle of the vehicle.

21-135. (canceled)
